(19) United States
(12) Patent Application Publication
(10) Pub. No.: US 2022/0124988 A1
(43) Pub. Date: Apr. 28, 2022

(54) TRELLIS PANELS FOR SUNLIGHT DELIVERY, SHOOT POSITIONING, AND CANOPY DIVISION

(71) Applicant: Opti-Harvest, Inc., Los Angeles, CA (US)

(72) Inventors: Nicholas BOOTH, Los Angeles, CA (US); Yosepha SHAHAK RAVID, Los Angeles, CA (US); William L. PEACOCK, Los Angeles, CA (US); Nadav RAVID, Los Angeles, CA (US); Daniel L. FARKAS, Los Angeles, CA (US); Jonathan DESTLER, Los Angeles, CA (US)

(21) Appl. No.: 17/571,937

(22) Filed: Jan. 10, 2022

Related U.S. Application Data
(63) Continuation of application No. PCT/US2020/044046, filed on Jul. 29, 2020.
(60) Provisional application No. 62/880,542, filed on Jul. 30, 2019.

(51) Int. Cl. A01G 13/02; A01G 17/06

(52) U.S. Cl. CPC A01G 13/0206; A01G 17/06

(57) ABSTRACT

Provided herein are devices, systems, and methods for sunlight delivery, shoot positioning, canopy division, positioning fruit into distinct zones, managing fruit maturity and quality, rain, wind, and hail protection, and reducing canopy management and harvest labor of one or more plants on a trellis comprising one or more panels and a standoff, wherein the panels divide the growth of plant shoots on the trellis, thereby modifying growth or development of the plants. In some embodiments, the panels collect light energy and direct the collected light energy to the plants, thereby modifying growth or development of the plants and their producing of fruit.

### CROSS-REFERENCE

This application is the continuation of International Application No. PCT/US2020/044046, filed on Jul. 29, 2020, which claims the benefit of U.S. Provisional Patent Application No. 62/880,542, entitled “TRELLIS PANELS FOR SHOOT POSITIONING AND CANOPY DIVISION,” filed on Jul. 30, 2019, which is entirely incorporated herein by reference for all purposes.

### BACKGROUND

Prior to 1990, California table grape trellises consisted of a “T” trellis comprising a T-bar and three to four foliage wires evenly spaced on top of the T-bar. This “T” trellis was used for over fifty years with little variation.

### SUMMARY

Provided herein are systems and methods for sunlight delivery, shoot positioning, canopy trellis division, and for positioning fruit into distinct zones of plants on trellises that cure the deficiencies associated with manual canopy division or moveable wire-assisted canopy division that suffer from cluster thinning, berry thinning, and increased harvest costs.

One aspect provided herein is a device for sunlight delivery, shoot positioning, and canopy management of one or more plants on a trellis, comprising one or more panels configured for coupling to the trellis, the panels configured to collect light energy and to direct the collected light energy to the plants, thereby modifying growth or development of the plants. In some embodiments, the one or more panels are detachably coupled to the trellis.

In some embodiments, the one or more panels are physically coupled to the trellis. In some embodiments, the one or more panels are functionally coupled to the trellis. In some embodiments, the one or more panels comprise one or more reflective panels. In some embodiments, the one or more reflective panels are configured to reflect the collected light energy to the plants, thereby directing the collected light energy to the climbing vine. In some embodiments, the one or more reflective panels are configured to encourage leaf and stem growth and in other to help ripen fruits, encourage leaf and stem growth, and improve plant productiveness, fruitfulness, and yield. In some embodiments, the one or more panels are red, yellow, or orange in color. In some embodiments, the one or more panels are configured to limit or eliminate reflection of blue light. In some embodiments, the one or more panels are configured to limit or eliminate reflection of ultraviolet (UV) light. In some embodiments, the one or more panels are blue in color. In some embodiments, the one or more panels are configured to limit or eliminate reflection of red, yellow, or orange light. In some embodiments, the one or more panels comprise one or more translucent panels.

In some embodiments, the one or more panels have a translucency of about 1% to about 90%. In some embodiments, the one or more panels have a translucency of about 1% to about 2%, about 1% to about 5%, about 1% to about 10%, about 1% to about 20%, about 1% to about 30%, about 1% to about 40%, about 1% to about 50%, about 1% to about 60%, about 1% to about 70%, about 1% to about 80%, about 1% to about 90%, about 2% to about 5%, about 2% to about 10%, about 2% to about 20%, about 2% to about 30%, about 2% to about 40%, about 2% to about 50%, about 2% to about 60%, about 2% to about 70%, about 2% to about 80%, about 2% to about 90%, about 5% to about 10%, about 5% to about 20%, about 5% to about 30%, about 5% to about 40%, about 5% to about 50%, about 5% to about 60%, about 5% to about 70%, about 5% to about 80%, about 5% to about 90%, about 10% to about 20%, about 10% to about 30%, about 10% to about 40%, about 10% to about 50%, about 10% to about 60%, about 10% to about 70%, about 10% to about 80%, about 10% to about 90%, about 20% to about 30%, about 20% to about 40%, about 20% to about 50%, about 20% to about 60%, about 20% to about 70%, about 20% to about 80%, about 20% to about 90%, about 30% to about 40%, about 30% to about 50%, about 30% to about 60%, about 30% to about 70%, about 30% to about 80%, about 30% to about 90%, about 40% to about 50%, about 40% to about 60%, about 40% to about 70%, about 40% to about 80%, about 40% to about 90%, about 50% to about 60%, about 50% to about 70%, about 50% to about 80%, about 50% to about 90%, about 60% to about 70%, about 60% to about 80%, about 60% to about 90%, about 70% to about 80%, about 70% to about 90%, or about 80% to about 90%. In some embodiments, the one or more panels have a translucency of about 1%, about 2%, about 5%, about 10%, about 20%, about 30%, about 40%, about 50%, about 60%, about 70%, about 80%, or about 90%. In some embodiments, the one or more panels have a translucency of at least about 1%, about 2%, about 5%, about 10%, about 20%, about 30%, about 40%, about 50%, about 60%, about 70%, or about 80%. In some embodiments, the one or more panels have a translucency of at most about 2%, about 5%, about 10%, about 20%, about 30%, about 40%, about 50%, about 60%, about 70%, about 80%, or about 90%.

In some embodiments, the one or more translucent panels are configured to diffuse the collected light energy to the plants, thereby directing the collected light energy to the climbing vine. In some embodiments, the one or more translucent panels are configured to encourage leaf and stem growth and in other to help ripen fruits and improve plant yields. In some embodiments, the one or more panels are red, yellow, or orange in color. In some embodiments, the one or more panels are configured to limit or eliminate diffusion of blue light. In some embodiments, the one or more panels are configured to limit or eliminate diffusion of ultraviolet (UV) light. In some embodiments, the one or more panels are blue in color. In some embodiments, the one or more panels are configured to limit or eliminate diffusion of red, yellow, or orange light. In some embodiments, the one or more panels comprise one or more translucent panels. In some embodiments, the one or more translucent panels are configured to diffuse the collected light energy to the plants, thereby directing the collected light energy to the climbing vine. In some embodiments, the one or more translucent panels are configured to encourage leaf and stem growth and in other to help ripen fruits and improve plant yields. In some embodiments, the one or more panels are red, yellow, or orange in color. In some embodiments, the one or more panels are configured to limit or eliminate diffusion of blue light. In some embodiments, the one or more panels are configured to limit or eliminate diffusion of ultraviolet (UV) light. In some embodiments, the one or more panels are blue in color. In some embodiments, the one or more panels are configured to limit or eliminate diffusion of red, yellow, or orange light. In some embodiments, the one or more panels comprise a curved shape. In some embodiments, the one or more panels comprise a parabolic, partial parabolic, or compound parabolic shape. In some embodiments, the one or more panels comprise a metallic material. In some embodiments, the one or more panels comprise a plastic material. In some embodiments, the one or more panels comprise one or more holes therethrough. In some embodiments, the one or more holes are configured to improve ventilation of the panels, to reduce heat load on the panels, to improve light transmission through the one or more panels, or any combination thereof. In some embodiments, the one or more holes are sized to prevent ingress of the plant through the one or more holes. In some embodiments, the one or more holes comprise a diameter of at most about 5 millimeters (mm). In some embodiments, the device further comprises one or more hole-closing units configured to close the one or more holes. In some embodiments, the one or more hole-closing units comprise one or more secondary panels. In some embodiments, the one or more secondary panels are configured to slide over the one or more panels. In some embodiments, the one or more hole-closing units comprise one or more strips of solid material coupled to the one or more panels. In some embodiments, the one or more strips of solid material are detachably coupled to the one or more panels. In some embodiments, the one or more strips of solid material are integrally coupled to the one or more panels. In some embodiments, the one or more strips of solid material are embedded in the one or more panels. In some embodiments, the one or more panels are configured to physically separate each plant of the one or more plants from each other plant of the one or more plants. In some embodiments, the one or more panels are configured to interlock. In some embodiments, the device further comprises one or more curtains coupled to an edge of the one or more panels, the curtains configured to protect the plants from rain. In some embodiments, the curtains comprise a metallic material. In some embodiments, the curtains comprise a plastic material. In some embodiments, the one or more panels are configured to maintain an area behind the one or more panels clear of foliage from the plants. In some embodiments, the one or more panels are configured to train the plants on the trellis. In some embodiments, the one or more panels are configured to provide shade to the plants. In some embodiments, the one or more panels are configured to protect the plants from rain. In some embodiments, the one or more panels are configured to protect the plants from frost. In some embodiments, the one or more panels are configured to protect the plants from hail. In some embodiments, the one or more panels are configured to protect the plants from sunburn. In some embodiments, the one or more panels are configured to fold up into a center of the trellis to ease pruning of the plants. In some embodiments, the one or more plants comprise one or more vines. In some embodiments, the one or more vines comprise one or more members selected from the group consisting of: grape vines, kiwifruit vines, berry vines, blueberry vines, blackberry vines, raspberry vines, strawberry vines, melon vines, kiwifruit vines, watermelon vines, cantaloupe vines, and honeydew vines. In some embodiments, the one or more plants comprise one or more trees. In some embodiments, the one or more trees comprise one or more members selected from the group consisting of: fruit trees, apple trees, stone-fruit trees, cherry trees, peach trees, nectarine trees, plum trees, apricot trees, citrus trees, orange trees, lemon trees, lime trees, grapefruit trees, pomelo trees, and tangerine trees. In some embodiments, the one or more panels comprise a portion of a roll of material. In some embodiments, the roll comprises a plurality of the one or more panels. In some embodiments, the roll of material comprises a continuous roll of material. In some embodiments, the roll of material comprises a length of about 660 feet (201.168 meters). In some embodiments, the roll of material comprises a length of about 1,320 feet (402.336 meters).

Another aspect provided herein is a device for sunlight delivery, shoot positioning, and canopy division of one or more plants on a trellis of one or more plants on a trellis, comprising: one or more panels configured for coupling to the trellis; and a standoff coupled to the trellis and at least a portion of each of the one or more panels; wherein the panels divide the growth of plant shoots on the trellis, thereby modifying sunlight delivery, shoot positioning, and canopy division of the plants.

In some embodiments, the one or more panels are detachably coupled to the trellis. In some embodiments, the standoff is detachably coupled to the trellis. In some embodiments, the one or more panels interlock. In some embodiments, the one or more panels are reflective. In some embodiments, the one or more panels are translucent.

In some embodiments, the one or more panels have a translucency of about 1% to about 90%. In some embodiments, the one or more panels have a translucency of about 1% to about 2%, about 1% to about 5%, about 1% to about 10%, about 1% to about 20%, about 1% to about 30%, about 1% to about 40%, about 1% to about 50%, about 1% to about 60%, about 1% to about 70%, about 1% to about 80%, about 1% to about 90%, about 2% to about 5%, about 2% to about 10%, about 2% to about 20%, about 2% to about 30%, about 2% to about 40%, about 2% to about 50%, about 2% to about 60%, about 2% to about 70%, about 2% to about 80%, about 2% to about 90%, about 5% to about 10%, about 5% to about 20%, about 5% to about 30%, about 5% to about 40%, about 5% to about 50%, about 5% to about 60%, about 5% to about 70%, about 5% to about 80%, about 5% to about 90%, about 10% to about 20%, about 10% to about 30%, about 10% to about 40%, about 10% to about 50%, about 10% to about 60%, about 10% to about 70%, about 10% to about 80%, about 10% to about 90%, about 20% to about 30%, about 20% to about 40%, about 20% to about 50%, about 20% to about 60%, about 20% to about 70%, about 20% to about 80%, about 20% to about 90%, about 30% to about 40%, about 30% to about 50%, about 30% to about 60%, about 30% to about 70%, about 30% to about 80%, about 30% to about 90%, about 40% to about 50%, about 40% to about 60%, about 40% to about 70%, about 40% to about 80%, about 40% to about 90%, about 50% to about 60%, about 50% to about 70%, about 50% to about 80%, about 50% to about 90%, about 60% to about 70%, about 60% to about 80%, about 60% to about 90%, about 70% to about 80%, about 70% to about 90%, or about 80% to about 90%. In some embodiments, the one or more panels have a translucency of about 1%, about 2%, about 5%, about 10%, about 20%, about 30%, about 40%, about 50%, about 60%, about 70%, about 80%, or about 90%. In some embodiments, the one or more panels have a translucency of at least about 1%, about 2%, about 5%, about 10%, about 20%, about 30%, about 40%, about 50%, about 60%, about 70%, or about 80%. In some embodiments, the one or more panels have a translucency of at most about 2%, about 5%, about 10%, about 20%, about 30%, about 40%, about 50%, about 60%, about 70%, about 80%, or about 90%.

In some embodiments, the one or more panels are chromatic. In some embodiments, the one or more panels are formed of a metallic material, a plastic material, or any combination thereof. In some embodiments, the one or more panels comprise a curved shape. In some embodiments, the one or more panels comprise a parabolic, partial parabolic, or compound parabolic shape. In some embodiments, the one or more panels comprise one or more holes therethrough. In some embodiments, the one or more holes improve ventilation of the one or more panels, reduce a heat load on the one or more panels, improve light transmission through the one or more panels, or any combination thereof. In some embodiments, the one or more holes are sized to prevent ingress of the plant through the one or more holes. In some embodiments, the one or more holes have a diameter of at most about 5 mm. In some embodiments, the device further comprises one or more hole-closing units configured to close the one or more holes. In some embodiments, the one or more hole-closing units comprise one or more secondary panels. In some embodiments, the one or more secondary panels are configured to slide over the one or more panels. In some embodiments, the one or more hole-closing units comprise one or more strips of solid material coupled to the one or more panels. In some embodiments, the one or more strips of solid material are detachably coupled to the one or more panels. In some embodiments, the one or more strips of solid material are integrally coupled to the one or more panels. In some embodiments, the one or more strips of solid material are embedded in the one or more panels. In some embodiments, the device further comprises one or more curtains coupled to an edge of the one or more panels. In some embodiments, the curtains are formed of a metallic material, a plastic material, a fabric, or both. In some embodiments, the one or more panels are configured to physically separate a first portion of the plant from a second portion of the plant. In some embodiments, the one or more panels are configured to train the plants on the trellis. In some embodiments, the one or more panels are configured to provide shade to the plants. In some embodiments, the one or more panels are configured to provide scattered/diffused light for illuminating shaded parts of the plant canopy. In some embodiments, the one or more panels are configured to protect the plants from rain, frost, hail, wind, sunburn or any combination thereof. In some embodiments, the one or more panels are configured to fold up into a center of the trellis for pruning of the plants. In some embodiments, the one or more panels are configured to allow illumination of an interior canopy of the one or more plants, a fruiting zone of the one or more plants, or both. In some embodiments, the one or more panels are configured to reduce, increase, or maintain a temperature in a fruiting zone of the one or more plants. In some embodiments, the one or more panels are configured to reduce light levels in a canopy of the one or more plants, a fruiting zone of the one or more plants, or both. In some embodiments, the one or more plants comprise one or more vines. In some embodiments, the one or more vines comprise one or more members selected from the group consisting of: grape vines, kiwifruit vines, berry vines, blueberry vines, blackberry vines, raspberry vines, strawberry vines, melon vines, watermelon vines, cantaloupe vines, and honeydew vines. In some embodiments, the one or more plants comprise one or more trees. In some embodiments, the one or more trees comprise one or more members selected from the group consisting of: fruit trees, apple trees, stone-fruit trees, cherry trees, peach trees, nectarine trees, plum trees, apricot trees, citrus trees, orange trees, lemon trees, lime trees, grapefruit trees, pomelo trees, and tangerine trees. In some embodiments, the one or more panels comprise a portion of a roll of material. In some embodiments, the roll comprises a plurality of the one or more panels. In some embodiments, the roll of material comprises a continuous roll of material. In some embodiments, the roll of material comprises a length of about 660 feet (201.168 meters). In some embodiments, the roll of material comprises a length of about 1,320 feet (402.336 meters).

In some embodiments, the standoff is formed of plastic, metal, wood, fiberglass, glass, or any combination thereof.

In some embodiments, the standoff has a length of about 4 inches to about 20 inches. In some embodiments, the standoff has a length of about 4 inches to about 6 inches, about 4 inches to about 8 inches, about 4 inches to about 10 inches, about 4 inches to about 12 inches, about 4 inches to about 14 inches, about 4 inches to about 16 inches, about 4 inches to about 18 inches, about 4 inches to about 20 inches, about 6 inches to about 8 inches, about 6 inches to about 10 inches, about 6 inches to about 12 inches, about 6 inches to about 14 inches, about 6 inches to about 16 inches, about 6 inches to about 18 inches, about 6 inches to about 20 inches, about 8 inches to about 10 inches, about 8 inches to about 12 inches, about 8 inches to about 14 inches, about 8 inches to about 16 inches, about 8 inches to about 18 inches, about 8 inches to about 20 inches, about 10 inches to about 12 inches, about 10 inches to about 14 inches, about 10 inches to about 16 inches, about 10 inches to about 18 inches, about 10 inches to about 20 inches, about 12 inches to about 14 inches, about 12 inches to about 16 inches, about 12 inches to about 18 inches, about 12 inches to about 20 inches, about 14 inches to about 16 inches, about 14 inches to about 18 inches, about 14 inches to about 20 inches, about 16 inches to about 18 inches, about 16 inches to about 20 inches, or about 18 inches to about 20 inches. In some embodiments, the standoff has a length of about 4 inches, about 6 inches, about 8 inches, about 10 inches, about 12 inches, about 14 inches, about 16 inches, about 18 inches, or about 20 inches. In some embodiments, the standoff has a length of at least about 4 inches, about 6 inches, about 8 inches, about 10 inches, about 12 inches, about 14 inches, about 16 inches, or about 18 inches. In some embodiments, the standoff has a length of at most about 6 inches, about 8 inches, about 10 inches, about 12 inches, about 14 inches, about 16 inches, about 18 inches, or about 20 inches.

In some embodiments, the one or more panels have a length of about 40 inches to about 160 inches. In some embodiments, the one or more panels have a length of about 40 inches to about 50 inches, about 40 inches to about 60 inches, about 40 inches to about 70 inches, about 40 inches to about 80 inches, about 40 inches to about 90 inches, about 40 inches to about 100 inches, about 40 inches to about 120 inches, about 40 inches to about 140 inches, about 40 inches to about 160 inches, about 50 inches to about 60 inches, about 50 inches to about 70 inches, about 50 inches to about 80 inches, about 50 inches to about 90 inches, about 50 inches to about 100 inches, about 50 inches to about 120 inches, about 50 inches to about 140 inches, about 50 inches to about 160 inches, about 60 inches to about 70 inches, about 60 inches to about 80 inches, about 60 inches to about 90 inches, about 60 inches to about 100 inches, about 60 inches to about 120 inches, about 60 inches to about 140 inches, about 60 inches to about 160 inches, about 70 inches to about 80 inches, about 70 inches to about 90 inches, about 70 inches to about 100 inches, about 70 inches to about 120 inches, about 70 inches to about 140 inches, about 70 inches to about 160 inches, about 80 inches to about 90 inches, about 80 inches to about 100 inches, about 80 inches to about 120 inches, about 80 inches to about 140 inches, about 80 inches to about 160 inches, about 90 inches to about 100 inches, about 90 inches to about 120 inches, about 90 inches to about 140 inches, about 90 inches to about 160 inches, about 100 inches to about 120 inches, about 100 inches to about 140 inches, about 100 inches to about 160 inches, about 120 inches to about 140 inches, about 120 inches to about 160 inches, or about 140 inches to about 160 inches. In some embodiments, the one or more panels have a length of about 40 inches, about 50 inches, about 60 inches, about 70 inches, about 80 inches, about 90 inches, about 100 inches, about 120 inches, about 140 inches, or about 160 inches. In some embodiments, the one or more panels have a length of at least about 40 inches, about 50 inches, about 60 inches, about 70 inches, about 80 inches, about 90 inches, about 100 inches, about 120 inches, or about 140 inches. In some embodiments, the one or more panels have a length of at most about 50 inches, about 60 inches, about 70 inches, about 80 inches, about 90 inches, about 100 inches, about 120 inches, about 140 inches, or about 160 inches.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1A displays an image of an exemplary device for sunlight delivery, shoot positioning, and canopy division of one or more plants on a trellis, in accordance with embodiments herein;

FIG. 1B displays a photograph corresponding to FIG. 1A, in accordance with embodiments herein;

FIG. 2A displays an image of a trellis with the exemplary device for sunlight delivery, shoot positioning, and canopy division of one or more plants on a trellis, in accordance with embodiments herein;

FIG. 2B displays a photograph corresponding to FIG. 2A, in accordance with embodiments herein;

FIG. 3A displays an image of an interior canopy with the exemplary device for sunlight delivery, shoot positioning, and canopy division of one or more plants on a trellis, in accordance with embodiments herein;

FIG. 3B displays a photograph corresponding to FIG. 3A, in accordance with embodiments herein;

FIG. 4A displays an image of an exemplary chromatic device for sunlight delivery, shoot positioning, and canopy division of one or more plants on a trellis, in accordance with embodiments herein;

FIG. 4B displays a photograph corresponding to FIG. 4A, in accordance with embodiments herein;

FIG. 5A displays an image of a trellis having a first portion with the exemplary device for sunlight delivery, shoot positioning, and canopy division of one or more plants on a trellis and a second portion without the exemplary device for sunlight delivery, shoot positioning, and canopy division of one or more plants on a trellis, in accordance with embodiments herein;

FIG. 5B displays a photograph corresponding to FIG. 5A, in accordance with embodiments herein;

FIG. 6A displays an image of a trellis without the exemplary device for sunlight delivery, shoot positioning, and canopy division of one or more plants on a trellis, in accordance with embodiments herein;

FIG. 6B displays a photograph corresponding to FIG. 6A, in accordance with embodiments herein;

FIG. 7A displays an image of an interior canopy without the exemplary device for sunlight delivery, shoot positioning, and canopy division of one or more plants on a trellis, in accordance with embodiments herein;

FIG. 7B displays a photograph corresponding to FIG. 7A, in accordance with embodiments herein;

FIG. 8 displays an illustration of a first exemplary gable trellis for sunlight delivery, shoot positioning, and canopy division of one or more plants, in accordance with embodiments herein;

FIG. 9 displays an illustration of a second exemplary gable trellis for sunlight delivery, shoot positioning, and canopy division of one or more plants, in accordance with embodiments herein;

FIG. 10A displays an illustration of an exemplary Tatura trellis for sunlight delivery, shoot positioning, and canopy division of one or more plants, in accordance with embodiments herein;

FIG. 10B displays an illustration of the exemplary Tatura trellis system coupled to plants, in accordance with embodiments herein;

FIG. 10C displays a photograph corresponding to FIG. 10B, in accordance with embodiments herein;

FIG. 11 displays exemplary transmission spectra through plastic panels of different colors, in accordance with embodiments herein;

FIG. 12 displays harvest yields for trellis panels that include holes and had a boat-like shape in comparison to a control, in accordance with embodiments herein;

FIG. 13 illustrates the effect of different colored panels on the time to maturity of Krissy seedless grapes, in accordance with embodiments herein;

FIG. 14 illustrates the effect of different color panels on fruitfulness of Krissy seedless grapes one year after application of a trellis panel, in accordance with embodiments herein;

FIG. 15 illustrates the results of different colored panels on light intensity in vine inner canopies near fruiting zones, in accordance with embodiments herein;

FIG. 16A displays an example of a panel comprising holes over the entire extent of the panel, in accordance with embodiments herein;

FIG. 16B displays an example of a panel comprising holes over a portion of the panel and a rain-protection strip over another portion of the panel, in accordance with embodiments herein;

FIG. 16C displays a photograph of a first exemplary panel comprising holes over a portion of the panel and a rain-protection strip over another portion of the panel, in accordance with embodiments herein; and

FIG. 16D displays a photograph of a second exemplary panel comprising holes over a portion of the panel and a rain-protection strip over another portion of the panel, in accordance with embodiments herein.

### DETAILED DESCRIPTION

In the late 1980s, the University of California began research with new V-shaped trellis designs which became popular. Although the gable trellis increased yield dramatically and in some cases doubled production, its effective use required labor-intensive shoot positioning and canopy division.

Solutions to improve the canopy division of the gable trellis included positioning shoots to the trellis arms and leaving the middle of the plant free of foliage to form two fruiting zones along each of the trellis arms. Although the trellis center remains open for only three or four weeks, the canopy division operation was necessary to organize the fruit zone (keeping shoots from heaping up in the bottom of the V) and to improve light during a critical period in the development of fruit buds. Canopy division also allows light into the canopy interior, which is critical for developing fruitful buds for the following year.

Canopy division is currently a manual process performed by positioning and securing shoots to wires on one trellis arm or the other using vine ties or training tape. Labor costs for such a manual division are prohibitively expensive. Further, manual canopy division tends to break shoots that crisscross each other. Alternatively, canopy division can be performed by placing two moveable wires in the middle of the trellis support cross-arm during plant dormancy, whereby the two wires are pulled over to the trellis arm to divide the canopy. Such moveable wires often fail to properly secure the vines, allowing inclement weather to easily blow shoots out of position and back into bottom of the trellis V. Shoots positioned by moveable wires or by hand can be dislodged and disorganized by high winds and inclement weather.

To protect such vines from sunburns of canopy and fruit, from fruit ambering, and from rain and inclement weather, growers currently cover the vine's canopy with plastic until harvest is complete. Such covers slow fruit maturation, reduce the light levels received by the canopy and fruiting zone, and increase the heat, humidity, and condensation in the canopy and fruiting zone. This plastic cover is used for only one season and then disposed, and the cost of the cover and the amount of labor required for installation and reinstallation is significant. The cost of labor and materials, in some cases, exceeds a thousand dollars per acre. The plastic has very low light transmittance and thus prevents sugar and color accumulation in the fruit.

Plant growth regulators, fungicides, pesticides, and foliar nutrients are currently sprayed onto the plants as concentrates (air carrier) or dilutes (water carrier). Both spray types require direct spray up and through the canopy. Spray, which does not come in contact with leaves and fruit, penetrates the vine and drifts into the atmosphere or drips to the ground.

Provided herein are devices and systems for sunlight delivery, shoot positioning, and canopy division, positioning fruit into distinct zones, managing fruit maturity and quality, and reducing canopy management and harvest labor. The devices and systems may also protect fruit from damaging weather, such as rain, wind, or excess sun exposure. The devices and systems may further provide spray coverage and may reduce or eliminate spray drift. The devices and systems herein represent a leap forward in trellising by enabling improved light management and climate conditions in the vine canopy and fruiting zones. The devices and systems for sunlight delivery, shoot positioning, and canopy division of one or more plants on a trellis herein overcome the deficiencies associated with manually canopy division or moveable wire-assisted canopy division.

Recognized herein are systems and methods for positioning fruit into distinct zones of plants on trellises that obviate the deficiencies associated with cluster thinning, berry thinning, and harvest.

The devices and systems herein enable increased crop production and improved fruit maturity and quality by directing growth of shoots parallel to one another and upward until the shoots cascade over the top of the trellis arms. Further the devices and systems herein may reduce or eliminate the need for vine positioning labor and single-season disposable products, and reduce cluster thinning, berry thinning, and harvest labor. Additionally, the shape and positioning of the devices and systems shield and secure the vine from frost, hail, rain, wind and sunburn damage. Further, the shape and positioning of the devices and systems maintain the position and integrity of the plant's shoots even under high winds. The devices and systems provide a shield that greatly reduces spray drift into the atmosphere and improves coverage of the fruiting zone and foliage. Additionally, as the devices and systems enable the center of the trellis to remain open all season, the interior canopy, fruit wood developing for next year, and fruiting zone are continuously illuminated in some embodiments. Such illumination increases flower cluster numbers and sizes the following years.

The devices and systems for sunlight delivery, shoot positions, and canopy division described herein may be applied to a variety of trellises or trellis systems, such as T trellises, standalone T trellises, gable trellises, closed gable trellises, open gable trellises, Tatura trellises, or any other trellis or trellis system.

### Devices and Systems for Shoot Positioning and Canopy Division

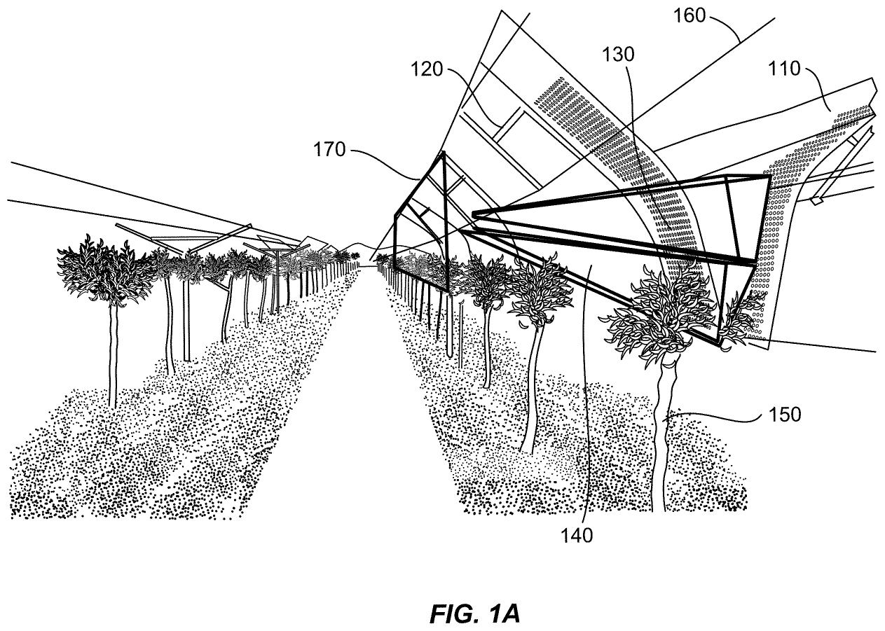

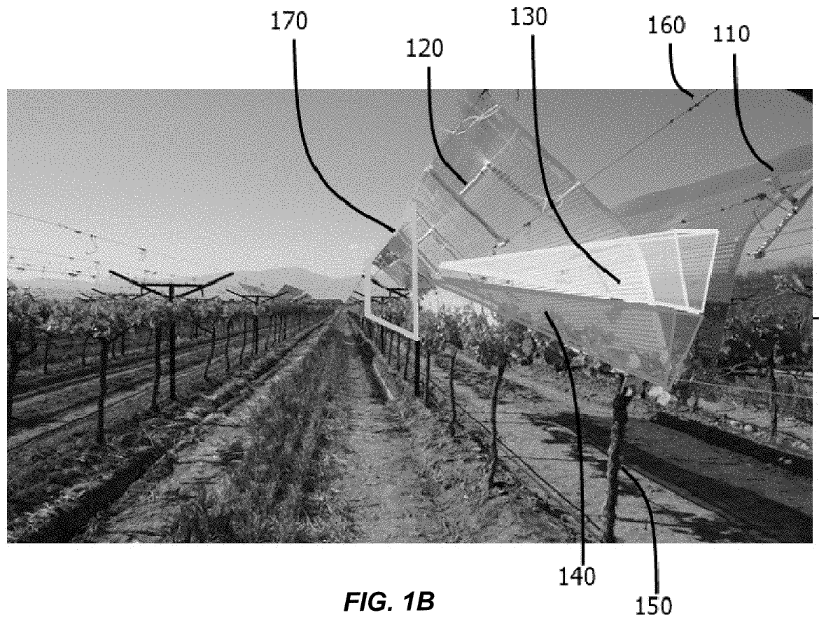

Provided herein per FIGS. 1-5 is a device for sunlight delivery, shoot positioning, and canopy division of one or more plants 150 on a trellis 160. In some embodiments, the device comprises one or more panels 110 and a standoff 120. In some embodiments, at least one of the one or more panels 110 and the standoff 120 are coupled to the trellis 160. In some embodiments, at least a portion of the one or more panels 110 is coupled to the trellis 160. In some embodiments, at least one of the one or more panels 110 and the standoff 120 are removably coupled to the trellis 160. In some embodiments, at least a portion of the one or more panels 110 is removably coupled to the trellis 160. In some embodiments, the panels 110 divide the growth of plant shoots 150 on the trellis 160, position shoots parallel to one another, divide the canopy of the plants 150, and establish distinct fruiting zones on both sides of the divided canopy. In some embodiments, the panels 110 collect light energy and direct the collected light energy to the plants 150, thereby modifying growth or development of the plants and fruit 150.

FIG. 1A displays an image of canopy management and harvest labor management on a trellis taken when shoot length was about 30 cm.

FIG. 1B displays a photograph corresponding to FIG. 1A.

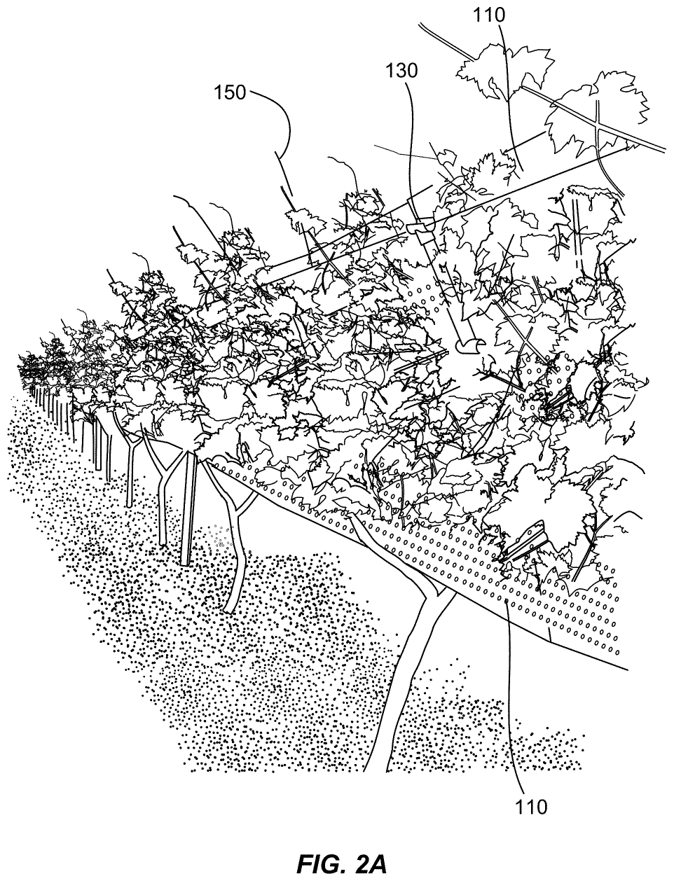

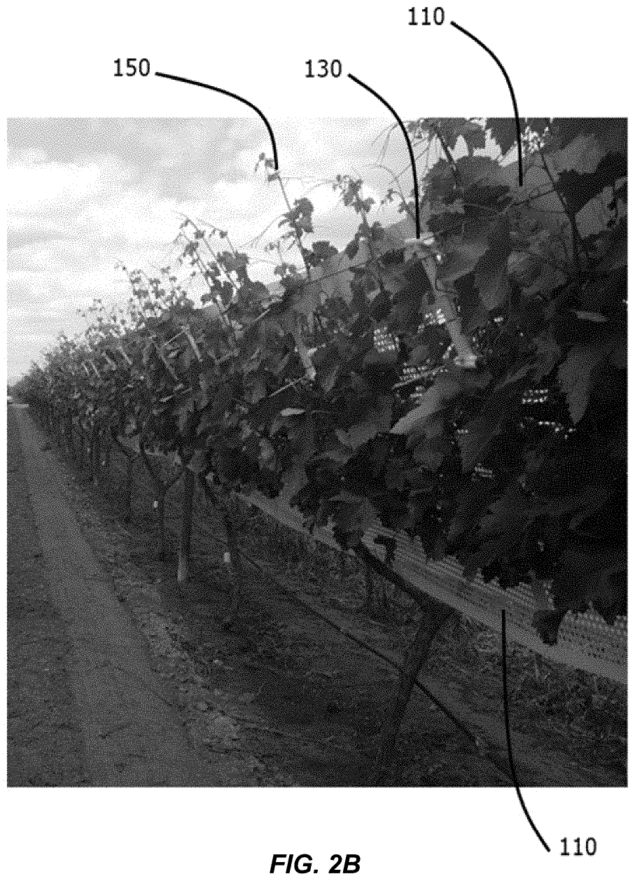

FIG. 2A displays an image of a trellis just prior to bloom when the trellis lacked the device for sunlight delivery, shoot positioning, and canopy division.

FIG. 2B displays a photograph corresponding to FIG. 2A.

In some embodiments, per FIGS. 1-3, the one or more panels 110 are configured to allow illumination of an interior canopy 130 of the one or more plants 150, a fruiting zone 140 of the one or more plants 150, or both. In some embodiments, the one or more panels 110 are configured to reduce, increase, or maintain a temperature in an interior canopy 130 of the one or more plants 150, a fruiting zone 140 of the one or more plants 150, or both. In some embodiments, the one or more panels 110 are configured to reduce light levels in the interior canopy 130 of the one or more plants 150, the fruiting zone 140 of the one or more plants 150, or both. In some embodiments, the one or more panels 110 are configured to physically separate a first portion of the plant 310 from a second portion of the plant 320. In some embodiments, the one or more panels 110 are configured to physically separate at least about 2, 3, 4, 5, 6, 7, 8, 9, 10, or more portions of the plant 320. In some embodiments, the one or more panels 110 are configured to physically separate at most about 10, 9, 8, 7, 6, 5, 4, 3, 2, or fewer portions of the plant 320. In some embodiments, the one or more panels 110 are configured to physical separate a number of portions of the plant 320 that is within a range defined by any two of the preceding values. In some embodiments, the one or more panels 110 are configured to train the plants 150 on the trellis 160. In some embodiments, the one or more panels 110 are configured to provide shade to the plants 150. In some embodiments, the one or more panels 110 are configured to provide scattered light or diffused light to illuminate shaded parts of the plant 150 canopy. In some embodiments, the one or more panels 110 are configured to protect the plants 150 from rain, frost, hail, wind, sunburn, or any combination thereof. In some embodiments, the one or more panels 110 are configured to shield the fruit and canopy from two or more directions. In some embodiments, fruit of the plant 150 is arranged in front of the shield. In some embodiments, the shield minimizes spray drift by blocking spray from penetrating the canopy and drifting into the atmosphere or onto the ground. In some embodiments, the defined zone of leaves and fruit of the plant 150 improves spray coverage of fruit and canopy. In some embodiments, the defined zone of leaves and fruit of the plant 150 formed by the shield minimizes drifting of spray into the atmosphere or onto the ground such that less spray is required for a specific volume of plant 150.

In some embodiments, the one or more panels 110 are configured to reduce, increase, or maintain a temperature in the interior canopy 130, the fruiting zone 140, or both. In some embodiments, the one or more panels 110 are configured to reduce, increase, or maintain a temperature in the interior canopy 130, the fruiting zone 140, or both to prevent maturation delay and prevent poor fruit quality.

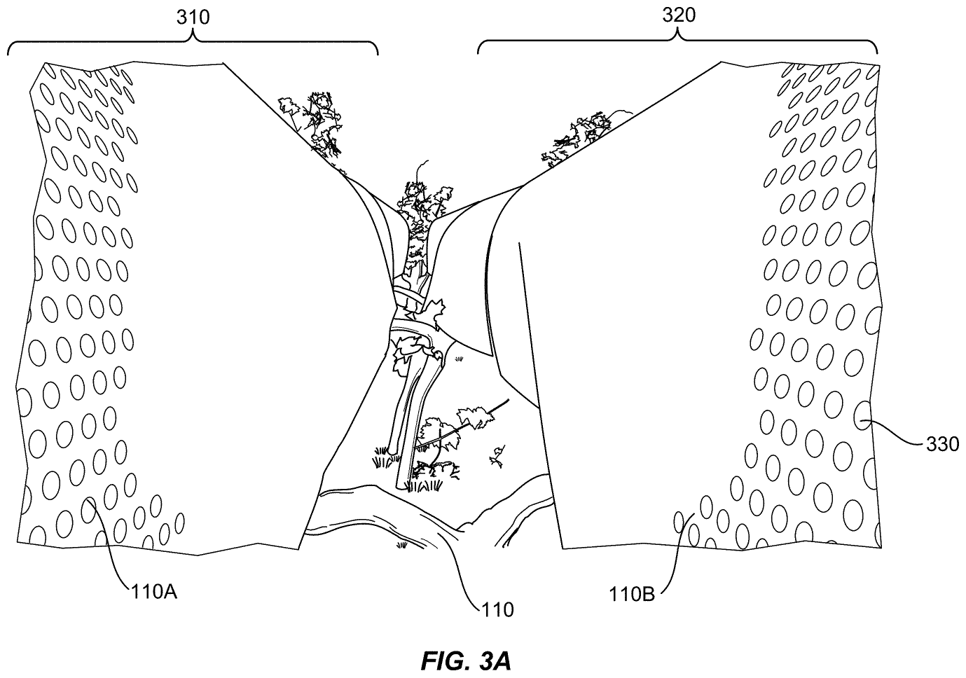

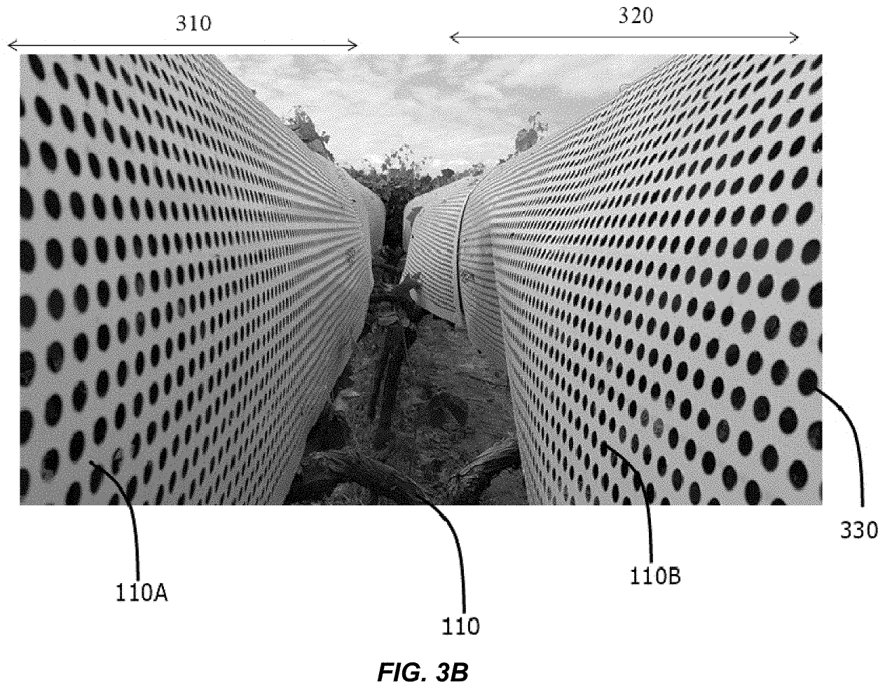

FIG. 3A displays an image of an interior canopy with the exemplary device for sunlight delivery, shoot positioning, and canopy division of one or more plants on a trellis.

FIG. 3B displays a photograph corresponding to FIG. 3A.

In some embodiments, per FIG. 3A, the one or more panels comprise one or more holes 330. In some embodiments, the one or more holes 330 improve ventilation of the one or more panels, reduce a heat load on the one or more panels, improve light transmission through the one or more panels, or any combination thereof. In some embodiments, the one or more holes 330 are sized to prevent ingress of the plant through the one or more holes 330. In some embodiments, the one or more holes 330 have a diameter of at most about 10 millimeters (mm), 9 mm, 8 mm, 7 mm, 6 mm, 5 mm, 4 mm, 3 mm, 2 mm, 1 mm, or less. In some embodiments, the one or more holes 330 have a diameter of at least about 1 mm, 2 mm, 3 mm, 4 mm, 5 mm, 6 mm, 7 mm, 8 mm, 9 mm, 10 mm, or more. In some embodiments, the one or more holes 330 have a diameter that is within a range defined by any two of the preceding values. In some embodiments, the one or more holes cover a portion of the area of the panel of at least about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, or more. In some embodiments, the one or more holes cover a portion of the area of the panel of at most about 80%, 79%, 78%, 77%, 76%, 75%, 74%, 73%, 72%, 71%, 70%, 69%, 68%, 67%, 66%, 65%, 64%, 63%, 62%, 61%, 60%, 59%, 58%, 57%, 56%, 55%, 54%, 53%, 52%, 51%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4%, 3%, 2%, 1%, or less. In some embodiments, the one or more holes cover a portion of the area of the panel that is within a range defined by any two of the preceding values. In some embodiments, the one or more panels comprise no holes. The percentage of the area of the panel covered by holes and the pattern by which holes are placed on the panels may be customized for a given trellis design or a given application (such as rain protection, wind protection, sun protection, and so forth).

Further, per FIG. 3A, in some embodiments the growth and development of each plant 150 is modified by two panels 110, wherein a first panel 110A modifies the growth of a first side of the plant 150, and wherein a second panel 110B modifies the growth of a second side of the plant 150. Alternatively, in some embodiments, the growth and development of each plant 150 is modified by at least about 1, 2, 3, 4, 5, 6, 7, 8, 9, 10, or more panels 110. In some embodiments, the growth and development of each plant 150 is modified by at most about 10, 9, 8, 7, 6, 5, 4, 3, 2, or 1 panels 110. In some embodiments, the growth and development of each plant is modified by a number of panels that is within a range defined by any two of the preceding values.

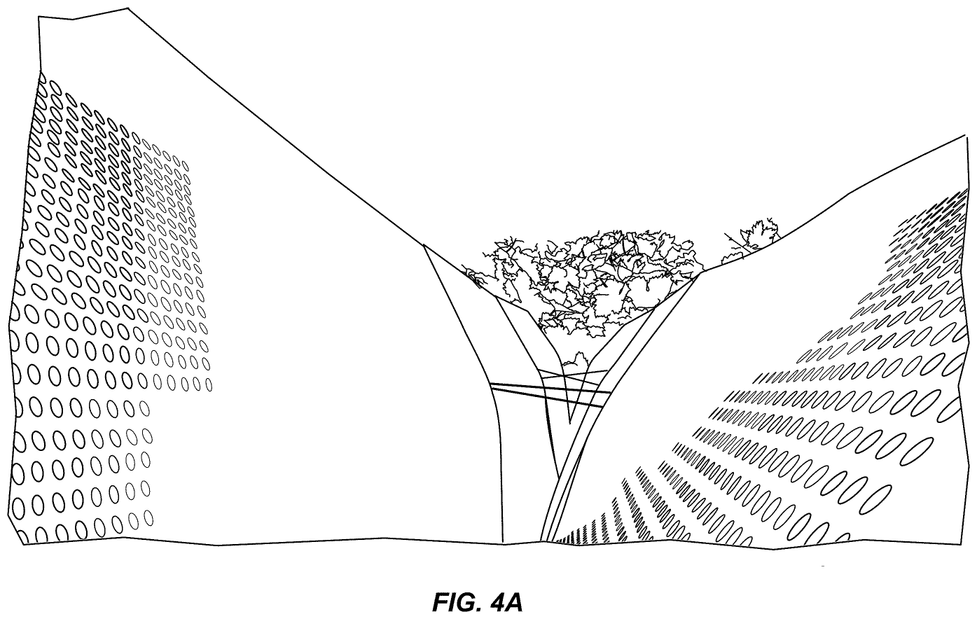

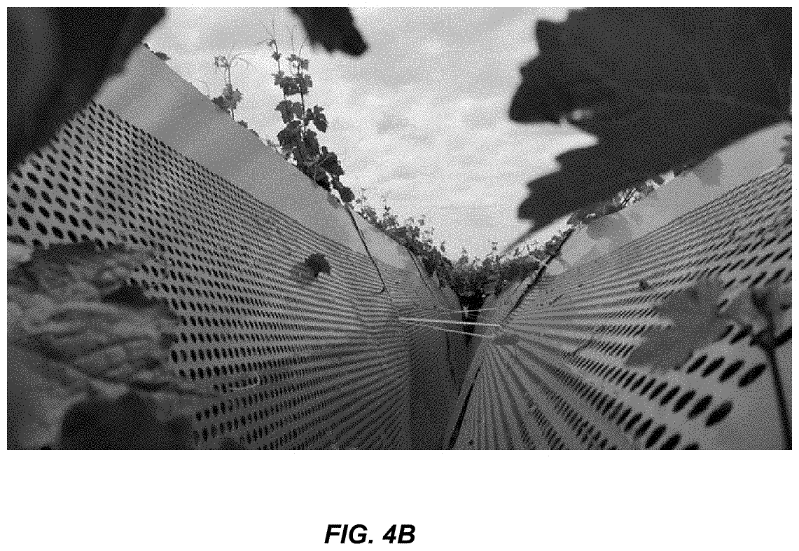

FIG. 4A displays an image of an exemplary chromatic device for sunlight delivery, shoot positioning, and canopy division of one or more plants on a trellis.

FIG. 4B displays a photograph corresponding to FIG. 4A.

In some embodiments, per FIG. 4A, the one or more panels 110 are chromatic. In some embodiments, the one or more chromatic panels are colored. In some embodiments, the color of the one or more chromatic panels are configured to provide spectrally modified light to the plants. In some embodiments, the color of the one or more chromatic panels 110 affects the plant and fruit physiology. In some embodiments, the one or more chromatic panels 110 are red, yellow, blue, or orange in color. In some embodiments, the one or more chromatic panels 110 prevent or reduce the reflection of blue, red, yellow, orange light or ultraviolet (UV). In some embodiments, a first portion of the one or more panels 110 is chromatic and a second portion of the one or more panels is not chromatic. In some embodiments, the one or more panels 110 are reflective. In some embodiments, a first portion of the one or more panels 110 is reflective and a second portion of the one or more panels is not reflective. In some embodiments, the one or more panels 110 are translucent. In some embodiments, a first portion of the one or more panels 110 is translucent and a second portion of the one or more panels is not translucent. In some embodiments, the one or more panels 110 comprise one or more translucent panels 110. In some embodiments, the one or more translucent panels 110 are configured to diffuse the collected light energy to the plants, thereby directing the collected light energy to the climbing vine. In some embodiments, the one or more translucent panels 110 are configured to encourage leaf and stem growth and in other to help ripen fruits and improve plant yields. In some embodiments, the one or more panels 110 are red, yellow, or orange in color. In some embodiments, the one or more panels 110 are configured to limit or eliminate diffusion of blue light. In some embodiments, the one or more panels 110 are configured to limit or eliminate diffusion of ultraviolet (UV) light. In some embodiments, the one or more panels 110 are blue in color. In some embodiments, the one or more panels 110 are configured to limit or eliminate diffusion of red, yellow, or orange light

In some embodiments, the one or more panels 110 are formed of a metallic material, a plastic material, or any combination thereof. For instance, in some embodiments, the one or more panels are formed of aluminum, steel, polyamides (PA), polycarbonates (PC), polyesters (PES), polyethylene (PE), high-density polyethylene (HDPE), low-density polyethylene (LDPE), polyethylene terephthalate (PET), polypropylene (PP), polystyrene (PS), high impact polystyrene (HIPS), polyurethanes (PU), polyvinyl chloride (PVC), polyvinylidene chloride (PVDC), acrylonitrile butadiene styrene (ABS), polyepoxides, polymethyl methylacrylate (PMMA), polytetrafluoroethylene (PTFE), phenol formaldehyde (PF), melamine formaldehyde (MF), urea-formaldehyde (UF), polyetheretherketone (PEEK), polyetherimide (PEI), polyimides, polylactic acid (PLA), furans, silicones, polysulfones, polydiketoenamines, or any combination thereof.

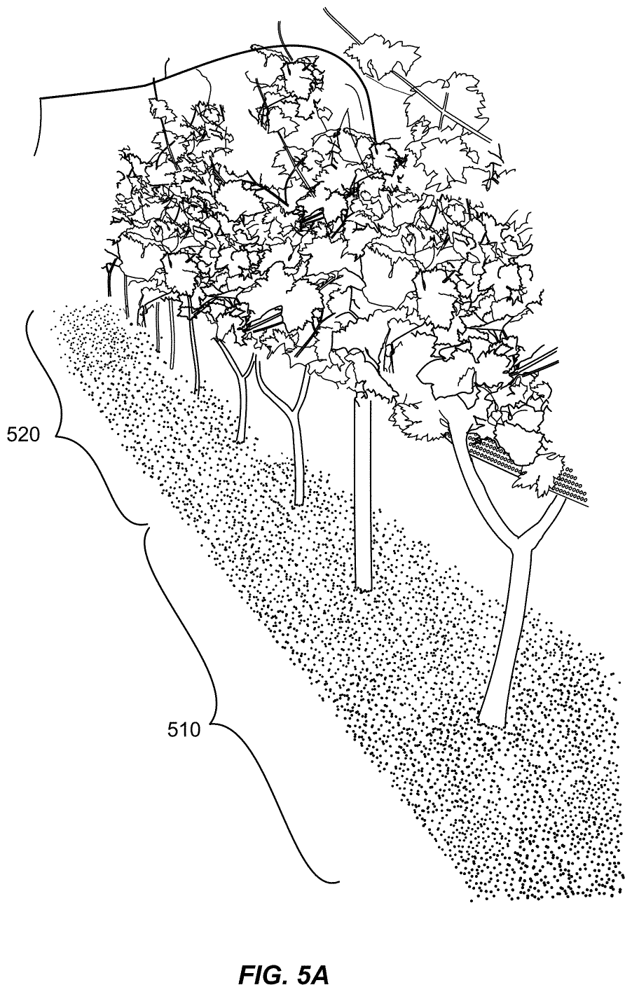

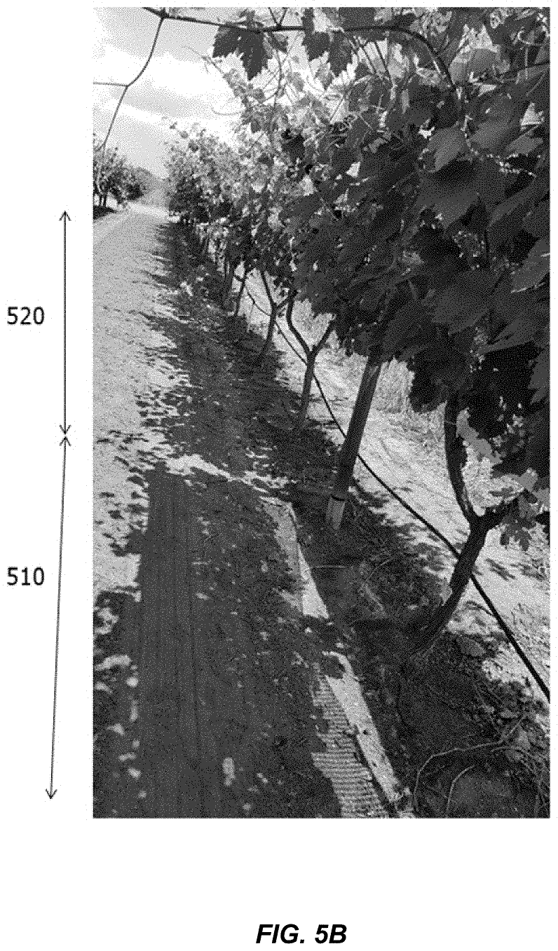

FIG. 5A displays an image of a trellis having a first portion with the exemplary device for sunlight delivery, shoot positioning, and canopy division of one or more plants on a trellis and a second portion without the exemplary device for sunlight delivery, shoot positioning, and canopy division of one or more plants on a trellis disclosed herein.

FIG. 5A shows the effects of the panels on the plants, whereby a properly divided canopy region 510 with the panels described herein displays a strip of light on the vineyard floor directly beneath the vines, at high noon during bloom, whereas an improperly divided canopy region 520 without the panels does not display a strip of light on the vineyard floor directly beneath the vines, at high noon during bloom. Further, a thicker ground shadow of the properly divided canopy region 510 indicates that more light was reflected by the panels or absorbed by the canopy foliage in the properly divided canopy region 510 than in the improperly divided canopy region 520. In some embodiments, a thicker ground shadow correlates with greater light adsorption by the plant 150 and improved light conditions in the interior canopy 130.

In some embodiments, the properly divided canopy region with the panels displays a strip of light having an intensity, at high noon during bloom, of at least about 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, 100%, or more, greater than an intensity, at high noon during bloom, of a strip of light displayed by an improperly divided canopy region without the panels. In some embodiments, the properly divided canopy region with the panels displays a strip of light having an intensity, at high noon during bloom, of at most about 100%, 95%, 90%, 85%, 80%, 75%, 70%, 65%, 60%, 55%, 50%, 45%, 40%, 35%, 30%, 25%, 20%, 15%, 10%, 9%, 8%, 7%, 6%, 5%, 4%, 3%, 2%, 1%, or less, greater than an intensity, at high noon during bloom, of a strip of light displayed by an improperly divided canopy region without the panels. In some embodiments, the properly divided canopy region with the panels displays a strip of light having an intensity, at high noon during bloom, that is within a range defined by any two of the preceding values, when compared to an intensity, at high noon during bloom, of a strip of light associated with an improperly divided canopy region without the panels.

FIG. 5B displays a photograph corresponding to FIG. 5B.

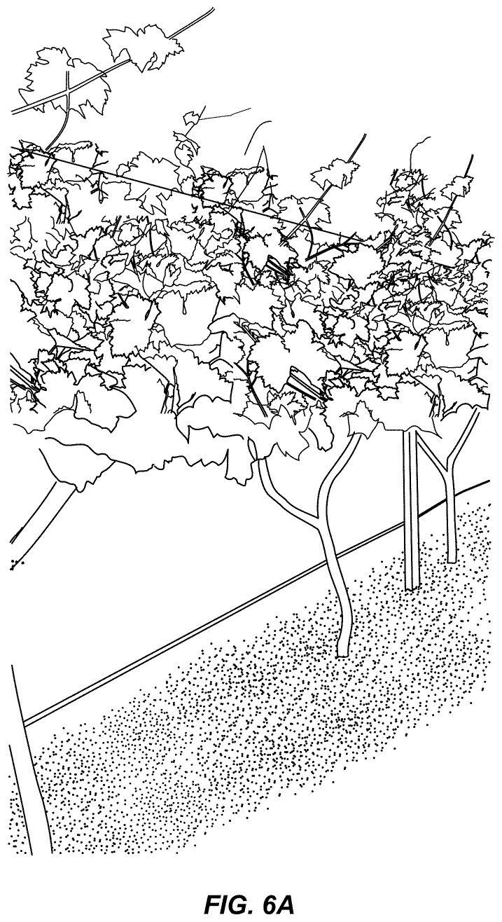

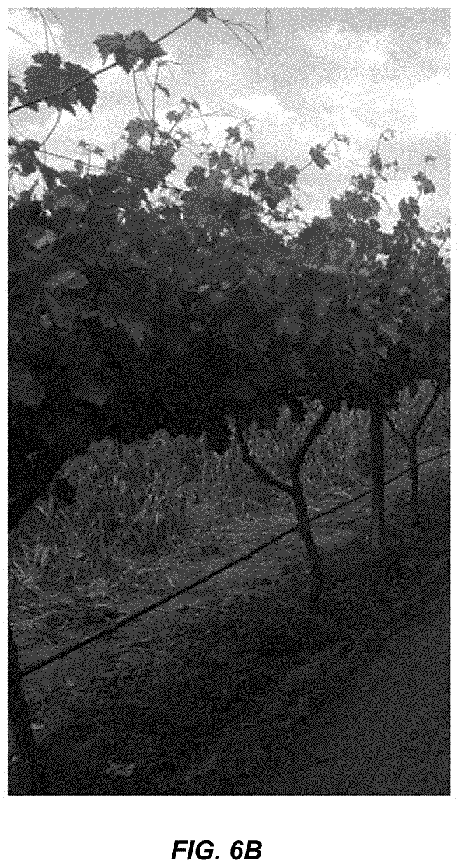

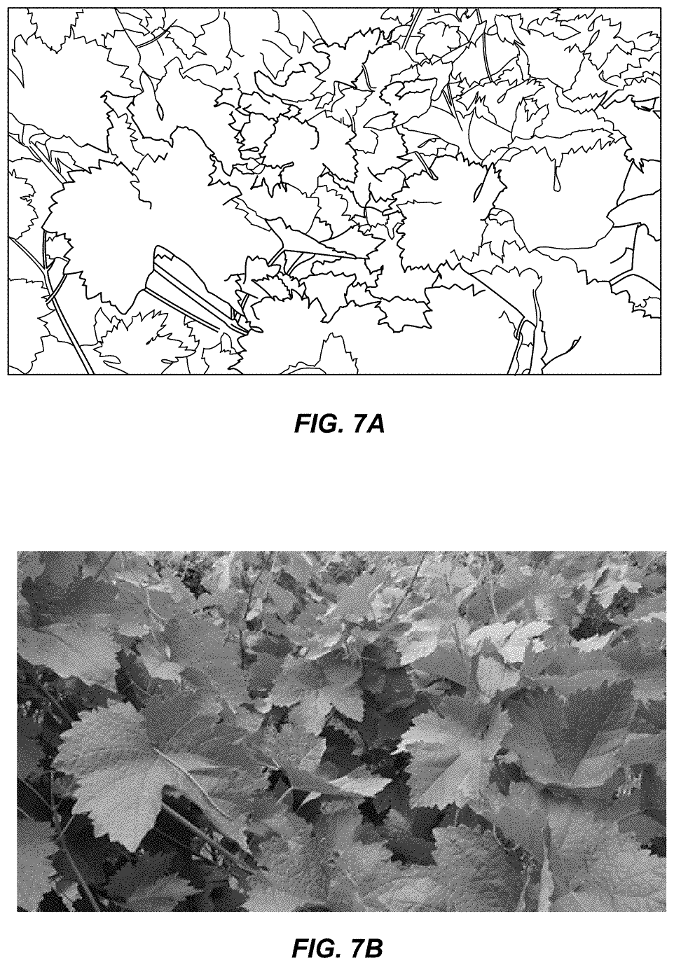

By contrast, per FIGS. 6A and 7A, a trellis 160 without the one or more panels prevents illumination from reaching the interior canopy 130 of the one or more plants 150, a fruiting zone 140 of the one or more plants 150, or both. In some embodiments, a trellis 160 without the one or more panels 110 exhibits increased temperatures in an interior canopy 130 of the one or more plants 150, a fruiting zone 140 of the one or more plants 150, or both. In some embodiments, the one or more panels 110 are configured to reduce, increase, or maintain a temperature in the interior canopy 130, the fruiting zone 140, or both to prevent maturation delay, prevent poor fruit quality, or prevent bud fruitfulness. In some embodiments, a trellis 160 without the one or more panels 110 exhibits increased light levels in the interior canopy 130 of the one or more plants 150, a fruiting zone 140 of the one or more plants 150, or both. In some embodiments, the trellis 160 without one or more panels 110 does not physically separate a first portion of the plant 310 from a second portion of the plant 320. In some embodiments, trellis 160 without the one or more panels 110 does not train the plants 150 on the trellis 160 where they grow wildly thereon. In some embodiments, the trellis 160 without one or more panels 110 does not provide shade to the plants 150. In some embodiments, the trellis 160 without one or more panels 110 does not provide scattered/diffused light for illuminating shaded parts of the plant canopy. In some embodiments, the trellis 160 without the one or more panels 110 does not protect the plants 150 from rain, frost, hail, sunburn, wind, or any combination thereof. In some embodiments, the trellis 160 without the one or more panels 110 allows spray drift as the spray penetrates into the air and leaves of the plant 150.

In some embodiments, the one or more panels 110 are detachably coupled to the trellis 160. In some embodiments, the one or more panels 110 interlock with each other. In some embodiments, the one or more panels 110 comprise a curved shape. In some embodiments, the one or more panels 110 comprise a parabolic, partial parabolic, or compound parabolic shape. In some embodiments, the curved shape comprises 1, 2, 3, 4 or more curves. In some embodiments, the curved shape comprises a flat portion and a curved portion. In some embodiments, the one or more panels 110 have a length of at least about 1 inch, 2 inches, 3 inches, 4 inches, 5 inches, 6 inches, 7 inches, 8 inches, 9 inches, 10 inches, 15 inches, 20 inches, 25 inches, 30 inches, 35 inches, 40 inches, 45 inches, 50 inches, 55 inches, 60 inches, 65 inches, 70 inches, 75 inches, 80 inches, 85 inches, 90 inches, 95 inches, 100 inches, 105 inches, 110 inches, 115 inches, 120 inches, 125 inches, 130 inches, 135 inches, 140 inches, 145 inches, 150 inches, 155 inches, 160 inches, 165 inches, 170 inches, 175 inches, 180 inches, 185 inches, 190 inches, 195 inches, 200 inches, or more. In some embodiments, the one or more panels 110 have a length of at most about 200 inches, 195 inches, 190 inches, 185 inches, 180 inches, 175 inches, 170 inches, 165 inches, 160 inches, 155 inches, 150 inches, 145 inches, 140 inches, 135 inches, 130 inches, 125 inches, 120 inches, 115 inches, 110 inches, 105 inches, 100 inches, 95 inches, 90 inches, 85 inches, 80 inches, 75 inches, 70 inches, 65 inches, 60 inches, 55 inches, 50 inches, 45 inches, 40 inches, 35 inches, 30 inches, 25 inches, 20 inches, 15 inches, 10 inches, 9 inches, 8 inches, 7 inches, 6 inches, 5 inches, 4 inches, 3 inches, 2 inches, 1 inch, or less. In some embodiments, the one or more panels 110 have a length that is within a range defined by any two of the preceding values. For instance, in some embodiments, the one or more panels 110 have a length of about 40 inches to about 160 inches. In some embodiments, the length of the panel 110 is measured as minimum, a maximum, or an average distance between an utmost point of the panel 110 and a downmost point of the panel 110. The length of the panel 110 may be customized for a given trellis design or a given application (such as rain protection, wind protection, sun protection, and so forth).

In some embodiments, the one or more panels 110 are configured to translate into a center of the trellis 160 for pruning of the plants. In some embodiments, the one or more panels 110 are configured to translate while being supported by a wire in the trellis. In some embodiments, the one or more panels 110 comprise a hinge, a pin, or both to fold.

In some embodiments, the device further comprises one or more curtains 170 coupled to an upper edge of the one or more panels 110. In some embodiments, the device further comprises one or more curtains 170 removably coupled to an upper edge of the one or more panels 110. In some embodiments, the curtains 170 are formed of a durable metallic material, a plastic material, a fabric, or both. In some embodiments, the curtains 170 are about 120 cm wide. In some embodiments, the curtains 170 provide protection from frost, hail, rain, sunburn, wind, or any combination thereof.

In some embodiments, the device further comprises one or more strips of material coupled to an upper edge, lower edge, center, or other location of the one or more panels 110. In some embodiments, the one or more strips of material have a linear dimension (such as a width or length) of at least about 1 inch, 2 inches, 3 inches, 4 inches, 5 inches, 6 inches, 7 inches, 8 inches, 9 inches, 10 inches, 11 inches, 12 inches, 13 inches, 14 inches, 15 inches, 16 inches, 17 inches, 18 inches, 19 inches, 20 inches, 21 inches, 22 inches, 23 inches, 24 inches, 25 inches, 26 inches, 27 inches, 28 inches, 29 inches, 30 inches, 31 inches, 32 inches, 33 inches, 34 inches, 35 inches, 36 inches, 37 inches, 38 inches, 39 inches, 40 inches, 41 inches, 42 inches, 43 inches, 44 inches, 45 inches, 46 inches, 47 inches, 48 inches, 49 inches, 50 inches, 51 inches, 52 inches, 53 inches, 54 inches, 55 inches, 56 inches, 57 inches, 58 inches, 59 inches, 60 inches, or more. In some embodiments, the one or more strips of material have a linear dimension of at most about 60 inches, 59 inches, 58 inches, 57 inches, 56 inches, 55 inches, 54 inches, 53 inches, 52 inches, 51 inches, 50 inches, 49 inches, 48 inches, 47 inches, 46 inches, 45 inches, 44 inches, 43 inches, 42 inches, 41 inches, 40 inches, 39 inches, 38 inches, 37 inches, 36 inches, 35 inches, 34 inches, 33 inches, 32 inches, 31 inches, 30 inches, 29 inches, 28 inches, 27 inches, 26 inches, 25 inches, 24 inches, 23 inches, 22 inches, 21 inches, 20 inches, 19 inches, 18 inches, 17 inches, 16 inches, 15 inches, 14 inches, 13 inches, 12 inches, 11 inches, 10 inches, 9 inches, 8 inches, 7 inches, 6 inches, 5 inches, 4 inches, 3 inches, 2 inches, 1 inch, or less. In some embodiments, the one or more strips of material have a linear dimension that is within a range defined by any two of the preceding values.

In some embodiments, the one or more strips of material cover a portion of the area of the panel of at least about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, or more. In some embodiments, the one or more strips of material cover a portion of the area of the panel of at most about 80%, 79%, 78%, 77%, 76%, 75%, 74%, 73%, 72%, 71%, 70%, 69%, 68%, 67%, 66%, 65%, 64%, 63%, 62%, 61%, 60%, 59%, 58%, 57%, 56%, 55%, 54%, 53%, 52%, 51%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4%, 3%, 2%, 1%, or less. In some embodiments, the one or more strips of material cover a portion of the area of the panel that is within a range defined by any two of the preceding values. In some embodiments, the one or more panels comprise no strips of material. The percentage of the area of the panel covered by the one or more strips of material and the pattern by which the one or more strips of material are placed on the panels may be customized for a given trellis design or a given application (such as rain protection, wind protection, sun protection, and so forth).

In some embodiments, the one or more strips of material provide protection from frost, hail, rain, sunburn, wind, or any combination thereof.

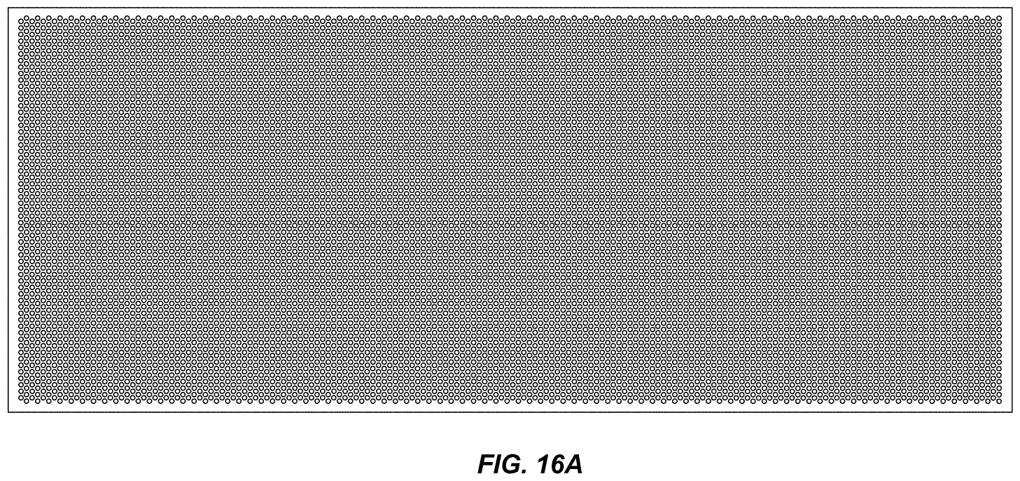

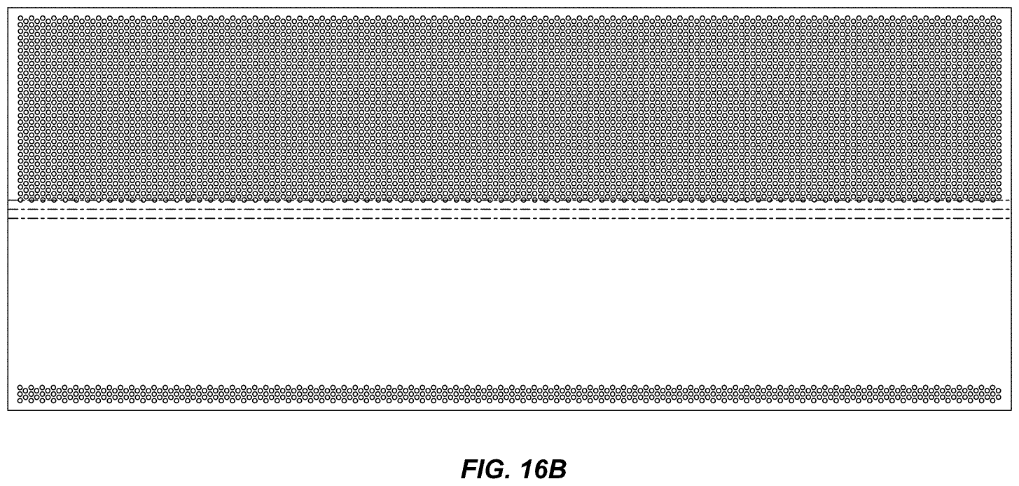

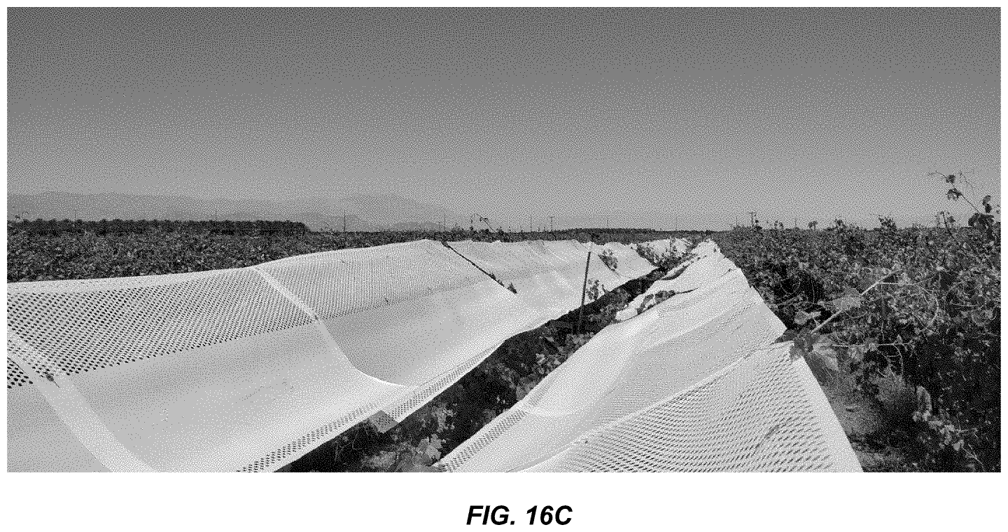

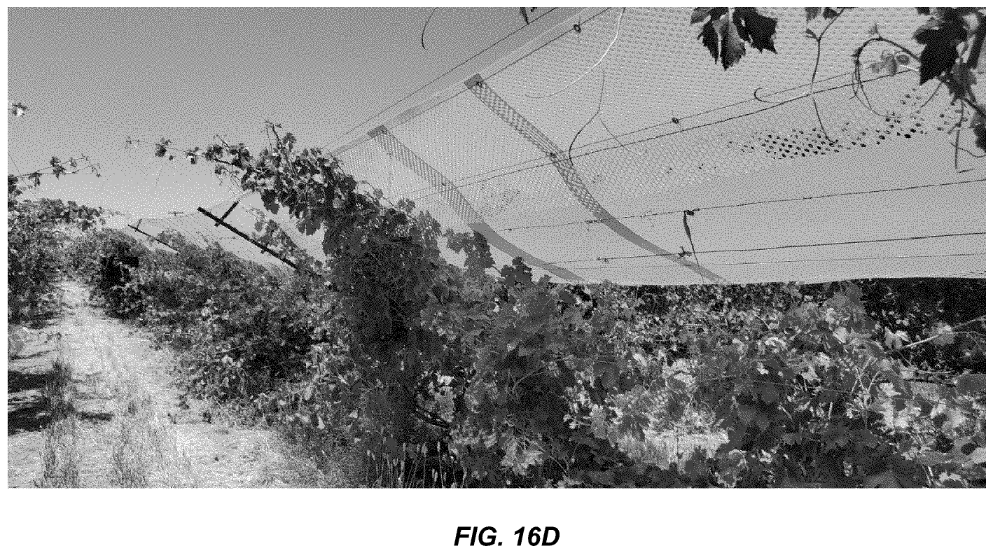

FIG. 16A displays an example of a panel comprising holes over the entire extent of the panel.

FIG. 16B displays an example of a panel comprising holes over a portion of the panel and a rain-protection strip over another portion of the panel.

FIG. 16C displays a photograph of a first exemplary panel comprising holes over a portion of the panel and a rain-protection strip over another portion of the panel.

FIG. 16D displays a photograph of a second exemplary panel comprising holes over a portion of the panel and a rain-protection strip over another portion of the panel.

FIG. 6A displays an image of a trellis without the exemplary device for sunlight delivery, shoot positioning, and canopy division of one or more plants on a trellis.

FIG. 6B displays a photograph corresponding to FIG. 6A.

FIG. 7A displays an image of an interior canopy without the exemplary device for sunlight delivery, shoot positioning, and canopy division of one or more plants on a trellis.

FIG. 7B displays a photograph corresponding to FIG. 7A.

### Standoffs

In some embodiments, per FIGS. 1A and 2A, the standoff 120 is formed of plastic, metal, wood, fiberglass, glass, or any combination thereof. In some embodiments, the standoff 120 is formed of any material disclosed herein. In some embodiments, the standoff 120 is detachably coupled to the trellis. In some embodiments, the standoff 120 has a length of at least about 1 inch, 2 inches, 3 inches, 4 inches, 5 inches, 6 inches, 7 inches, 8 inches, 9 inches, 10 inches, 11 inches, 12 inches, 13 inches, 14 inches, 15 inches, 16 inches, 17 inches, 18 inches, 19 inches, 20 inches, 21 inches, 22 inches, 23 inches, 24 inches, or more. In some embodiments, the standoff 120 has a length of at most about 24 inches, 23 inches, 22 inches, 21 inches, 20 inches, 19 inches, 18 inches, 17 inches, 16 inches, 15 inches, 14 inches, 13 inches, 12 inches, 11 inches, 10 inches, 9 inches, 8 inches, 7 inches, 6 inches, 5 inches, 4 inches, 3 inches, 2 inches, 1 inch, or less. In some embodiments, the standoff 120 has a length that is within a range defined by any two of the preceding values. In some embodiments, the standoff 120 has a length of about 4 inches to about 20 inches. In some embodiments, the standoff 120 is coupled to the trellis 160, the panel 110, or both. In some embodiments, the standoff 120 is removably coupled to the trellis 160, the panel 110, or both. In some embodiments, the standoff 120 is integrated into the trellis 160. In some embodiments, the standoff 120 comprises a wire. In some embodiments, the device for sunlight delivery, shoot positioning, and canopy division of one or more plants on a trellis of one or more plants on a trellis does not comprise the standoff 120.

### Panel Holes and Hole-Closing Units

In some embodiments, per FIG. 3A, the one or more panels comprise one or more holes 330 therethrough. In some embodiments, per FIG. 3A, the one or more panels comprise one or more holes 330 therethrough. In some embodiments, the one or more holes 330 improve ventilation of the one or more panels, reduce a heat load on the one or more panels, improve light transmission through the one or more panels, or any combination thereof. In some embodiments, the one or more holes 330 are sized to prevent ingress of the plant through the one or more holes 330. In some embodiments, the one or more holes 330 have a diameter of at most about 10 mm, 9 mm, 8 mm, 7 mm, 6 mm, 5 mm, 4 mm, 3 mm, 2 mm, 1 mm, or less. In some embodiments, the one or more holes 330 have a diameter of at least about 1 mm, 2 mm, 3 mm, 4 mm, 5 mm, 6 mm, 7 mm, 8 mm, 9 mm, 10 mm, or more. In some embodiments, the one or more holes 330 have a diameter that is within a range defined by any two of the preceding values. In some embodiments, the one or more holes cover a portion of the area of the panel of at least about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, or more. In some embodiments, the one or more holes cover a portion of the area of the panel of at most about 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4%, 3%, 2%, 1%, or less. In some embodiments, the one or more holes cover a portion of the area of the panel that is within a range defined by any two of the preceding values.

In some embodiments, the device further comprises one or more hole-closing units, alternatively termed as a cover, which is configured to removably close the one or more holes 330. In some embodiments, the one or more hole-closing units comprise one or more secondary panels. In some embodiments, the one or more hole-closing units comprise one or more secondary panels that close the holes 330 when in a first position and open the holes when in a second position. In some embodiments, the one or more secondary panels are configured to slide over the one or more panels 110. In some embodiments, the one or more secondary panels are configured to translate from the first position to the second position by sliding over the one or more panels 110. In some embodiments, the one or more secondary panels are configured to rotate from the first position to the second position with respect to the one or more panels 110. In some embodiments, at least one of the secondary panels and the panels 110 comprise a slide, a bearing, a rail, a pulley, a gear, a cam, a pinion, a rack, or any combination thereof to rotate or translate with respect to the one or more panels 110. In some embodiments, the one or more hole-closing units are configured to be reusable and easily installed onto the panels such that replacement of a damaged hole-closing unit is simple and inexpensive. In some embodiments, the one or more secondary panels provides protection from frost, hail, rain, wind, sunburn or any combination thereof when the hole closing units are in the opened position. In some embodiments, the one or more secondary panels provides protection from frost, hail, rain, wind, sunburn, or any combination thereof when the hole closing units are removed. In some embodiments, the one or more secondary panels provide protection from frost, hail, rain, sunburn, wind, or any combination thereof only with the hole-closing units are in the closed position. In some embodiments, the one or more secondary panels provide improved protection from frost, hail, rain, wind, sunburn, or any combination thereof when the hole-closing units are installed.

In some embodiments, the one or more hole-closing units comprise one or more strips of solid material coupled to the one or more panels. In some embodiments, the one or more strips of solid material are detachably coupled to the one or more panels. In some embodiments, the one or more strips of solid material are integrally coupled to the one or more panels. In some embodiments, the one or more strips of solid material are embedded in the one or more panels. In some embodiments, the one or more strips of solid material have a linear dimension (such as a width or length) of at least about 1 inch, 2 inches, 3 inches, 4 inches, 5 inches, 6 inches, 7 inches, 8 inches, 9 inches, 10 inches, 11 inches, 12 inches, 13 inches, 14 inches, 15 inches, 16 inches, 17 inches, 18 inches, 19 inches, 20 inches, 21 inches, 22 inches, 23 inches, 24 inches, 25 inches, 26 inches, 27 inches, 28 inches, 29 inches, 30 inches, 31 inches, 32 inches, 33 inches, 34 inches, 35 inches, 36 inches, or more. In some embodiments, the one or more strips of solid material have a linear dimension of at most about 36 inches, 35 inches, 34 inches, 33 inches, 32 inches, 31 inches, 30 inches, 29 inches, 28 inches, 27 inches, 26 inches, 25 inches, 24 inches, 23 inches, 22 inches, 21 inches, 20 inches, 19 inches, 18 inches, 17 inches, 16 inches, 15 inches, 14 inches, 13 inches, 12 inches, 11 inches, 10 inches, 9 inches, 8 inches, 7 inches, 6 inches, 5 inches, 4 inches, 3 inches, 2 inches, 1 inch, or less. In some embodiments, the one or more strips of solid material have a linear dimension that is within a range defined by any two of the preceding values.

In some embodiments, the one or more panels comprise one or more portions of a roll of material. In some embodiments, the roll of material comprises a plurality of the one or more panels. In some embodiments, the roll of material comprises a continuous roll of material. In some embodiments, the continuous roll of material is configured to be rolled out along a row or column of plants and trellises, such that one or more panels of the continuous roll of material is coupled to each plant and trellis in the row or column. Such a system may allow for decreased production costs due to economies of scale or to decreased labor costs due to the ease of unrolling the roll along a row or column of plants. In some embodiments, the roll of material comprises a length of at least about 165 feet ( 1/32 of a mile, 50.292 meters), 330 feet ( 1/16 of a mile, 100.584 meters), 660 feet (⅛ of a mile, 201.168 meters), 1,320 feet (¼ of a mile, 402.336 meters), 2,640 feet (½ of a mile, 804.672 meters), 5,280 feet (1 mile, 1,609.344 meters), or more. In some embodiments, the roll of material comprises a length of at most about 5,280 feet, 2,640 feet, 1,320 feet, 660 feet, 330 feet, 165 feet, or less. In some embodiments, the roll of material comprises a length that is within a range defined by any two of the preceding values.

### Trellis for Sunlight Delivery, Shoot Positioning, and Canopy Division

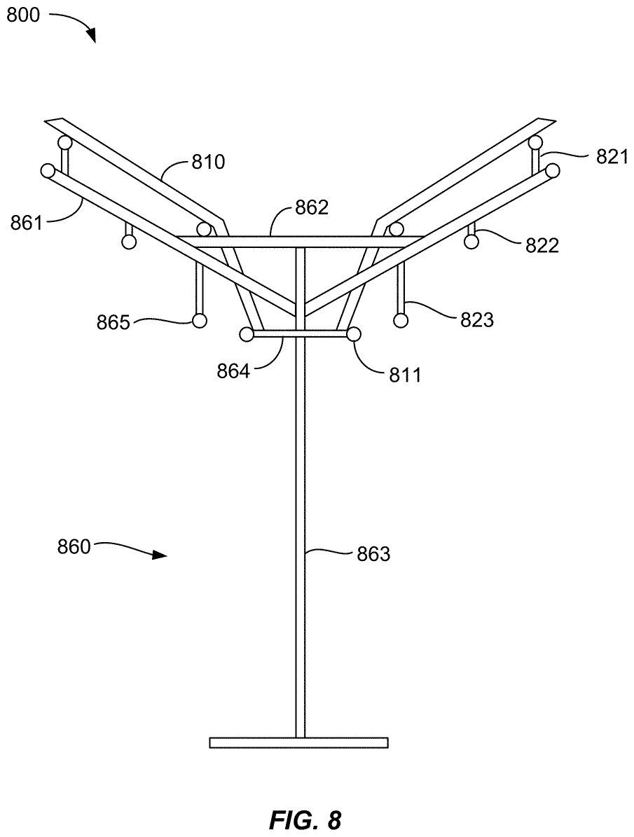

FIG. 8 displays an illustration of a first exemplary gable trellis system 800 for sunlight delivery, shoot positioning, and canopy division of one or more plants. As shown the exemplary trellis system 800 comprises a panel 810 and a trellis 860, wherein the panel 810 comprises one or more panel support wires 811, and wherein the trellis 860 comprises one or more gable arms 861, one or more first risers 821, one or more first drops 822, one or more second drops 823, a first cross arm 862, a second cross arm 864, a stake 863, and one or more cordon wires 865.

As shown in FIG. 8, the panel 810 comprises six panel support wires 811 (three per gable arm). In some embodiments, the panel 810 comprises at least about 2, 3, 4, 5, 6, 7, 8, 9, 10, or more panel support wires 811. In some embodiments, the panel 810 comprises at most about 10, 9, 8, 7, 6, 5, 4, 3, 2, or fewer panel support wires 811. In some embodiments, the panel 810 comprises a number of panel support wires that is within a range defined by any two of the preceding values. In some embodiments, the panel support wires 811 support the panel 810. In some embodiments, the panel 810 comprises any number of panels described herein, such as two or more panels. In some embodiments, the one or more gable arms 861 have a length of at least about 0.5 feet, 1 foot, 1.5 feet, 2 feet, 2.5 feet, 3 feet, 3.5 feet, 4 feet, 4.5 feet, 5 feet, 5.5 feet, 6 feet, 6.5 feet, 7 feet, 7.5 feet, 8 feet, 8.5 feet, 9 feet, 9.5 feet, 10 feet, or more. In some embodiments, the one or more gable arms 861 have a length of at most about 10 feet, 9.5 feet, 9 feet, 8.5 feet, 8 feet, 7.5 feet, 7 feet, 6.5 feet, 6 feet, 5.5 feet, 5 feet, 4.5 feet, 4 feet, 3.5 feet, 3 feet, 2.5 feet, 2 feet, 1.5 feet, 1 foot, 0.5 feet, or less. In some embodiments, the one or more gable arms 861 have a length that is within a range defined by any two of the preceding values. For instance, in some embodiments, the one or more gable arms 861 have a length of about 1.5 feet to about 6 feet.

In some embodiments, the first riser, the first drop, or the second drop have a length of at least about 1 inch, 2 inches, 3 inches, 4 inches, 5 inches, 6 inches, 7 inches, 8 inches, 9 inches, 10 inches, 11 inches, 12 inches, 13 inches, 14 inches, 15 inches, 16 inches, 17 inches, 18 inches, 19 inches, 20 inches, 21 inches, 22 inches, 23 inches, 24 inches, or more. In some embodiments, the first riser, the first drop, or the second drop have a length of at most about 24 inches, 23 inches, 22 inches, 21 inches, 20 inches, 19 inches, 18 inches, 17 inches, 16 inches, 15 inches, 14 inches, 13 inches, 12 inches, 11 inches, 10 inches, 9 inches, 8 inches, 7 inches, 6 inches, 5 inches, 4 inches, 3 inches, 2 inches, 1 inch, or fewer. In some embodiments, the first riser, the first drop, or the second drop have a length that is within a range defined by any two of the preceding values. For instance, in some embodiments, the first riser 821 has a length of about 3 inches to about 12 inches. For instance, in some embodiments, the first drop 822 has a length of about 2 inches to about 8 inches. For instance, in some embodiments, the second drop 823 has a length of about 4 inches to about 16 inches. Though depicted as comprising one riser and two drops in FIG. 8A, the trellis may comprise any number of risers and any number of drops. For instance, the trellis may comprise at least about 1, 2, 3, 4, 5, 6, 7, 8, 9, 10, or more risers. The trellis may comprise at most about 10, 9, 8, 7, 6, 5, 4, 3, 2, 1, or fewer risers. The trellis may comprise a number of risers that is within a range defined by any two of the preceding values. The trellis may comprise at least about 1, 2, 3, 4, 5, 6, 7, 8, 9, 10, or more drops. The trellis may comprise at most about 10, 9, 8, 7, 6, 5, 4, 3, 2, 1, or fewer drops. The trellis may comprise a number of drops that is within a range defined by any two of the preceding values.

In some embodiments, the first cross arm 862 or the second cross arm 864 has a length of at least about 0.5 feet, 1 foot, 1.5 feet, 2 feet, 2.5 feet, 3 feet, 3.5 feet, 4 feet, 4.5 feet, 5 feet, 5.5 feet, 6 feet, 6.5 feet, 7 feet, 7.5 feet, 8 feet, 8.5 feet, 9 feet, 9.5 feet, 10 feet, or more. In some embodiments, the first cross arm or the second cross arm has a length of at most about 10 feet, 9.5 feet, 9 feet, 8.5 feet, 8 feet, 7.5 feet, 7 feet, 6.5 feet, 6 feet, 5.5 feet, 5 feet, 4.5 feet, 4 feet, 3.5 feet, 3 feet, 2.5 feet, 2 feet, 1.5 feet, 1 foot, 0.5 feet, or less. In some embodiments, the first cross arm or the second cross arm has a length that is within a range defined by any two of the preceding values. For instance, in some embodiments, the first cross arm 862 has a length of about 1.5 feet to about 6 feet. For instances, in some embodiments, the second cross arm 864 has a length of about 1 foot to about 4 feet. In some embodiments, the first cross arm 862 and the second cross arm 863 form an angle. In some embodiments, the angle is at least about 10 degrees, 11 degrees, 12 degrees, 13 degrees, 14 degrees, 15 degrees, 16 degrees, 17 degrees, 18 degrees, 19 degrees, 20 degrees, 21 degrees, 22 degrees, 23 degrees, 24 degrees, 25 degrees, 26 degrees, 27 degrees, 28 degrees, 29 degrees, 30 degrees, 31 degrees, 32 degrees, 33 degrees, 34 degrees, 35 degrees, 36 degrees, 37 degrees, 38 degrees, 39 degrees, 40 degrees, 41 degrees, 42 degrees, 43 degrees, 44 degrees, 45 degrees, 46 degrees, 47 degrees, 48 degrees, 49 degrees, 50 degrees, 51 degrees, 52 degrees, 53 degrees, 54 degrees, 55 degrees, 56 degrees, 57 degrees, 58 degrees, 59 degrees, 60 degrees, 61 degrees, 62 degrees, 63 degrees, 64 degrees, 65 degrees, 66 degrees, 67 degrees, 68 degrees, 69 degrees, 70 degrees, or more. In some embodiments, the angle is at most about 70 degrees, 69 degrees, 68 degrees, 67 degrees, 66 degrees, 65 degrees, 64 degrees, 63 degrees, 62 degrees, 61 degrees, 60 degrees, 59 degrees, 58 degrees, 57 degrees, 56 degrees, 55 degrees, 54 degrees, 53 degrees, 52 degrees, 51 degrees, 50 degrees, 49 degrees, 48 degrees, 47 degrees, 46 degrees, 45 degrees, 44 degrees, 43 degrees, 42 degrees, 41 degrees, 40 degrees, 39 degrees, 38 degrees, 37 degrees, 36 degrees, 35 degrees, 34 degrees, 33 degrees, 32 degrees, 31 degrees, 30 degrees, 29 degrees, 28 degrees, 27 degrees, 26 degrees, 25 degrees, 24 degrees, 23 degrees, 22 degrees, 21 degrees, 20 degrees, 19 degrees, 18 degrees, 17 degrees, 16 degrees, 15 degrees, 14 degrees, 13 degrees, 12 degrees, 11 degrees, 10 degrees, or less. In some embodiments, the angle is within a range defined by any two of the preceding values. For instance, in some embodiments, the angle is between 10 degrees and 60 degrees.

In some embodiments, the stake 863 has a length of at least about 1 foot, 2 feet, 3 feet, 4 feet, 5 feet, 6 feet, 7 feet, 8 feet, 9 feet, 10 feet, 11 feet, 12 feet, 13 feet, 14 feet, 15 feet, 16 feet, 17 feet, 18 feet, 19 feet, 20 feet, or more. In some embodiments, the stake 863 has a length of at most about 20 feet, 19 feet, 18 feet, 17 feet, 16 feet, 15 feet, 14 feet, 13 feet, 12 feet, 11 feet, 10 feet, 9 feet, 8 feet, 7 feet, 6 feet, 5 feet, 4 feet, 3 feet, 2 feet, 1 foot, or less. In some embodiments, the stake 863 has a length that is within a range defined by any two of the preceding values. For instance, in some embodiments, the stake 863 has a height of about 4 feet to about 16 feet. As shown the trellis system 800 comprises two cordon wires 865. In some embodiments, the trellis system 800 comprises at least about 1, 2, 3, 4, 5, 6, 7, 8, 9, 10, or more cordon wires 865. In some embodiments, the trellis system 800 comprises at most about 10, 9, 8, 7, 6, 5, 4, 3, 2, 1, or fewer cordon wires 865. In some embodiments, the trellis system 800 comprises a number of cordon wires that is within a range defined by any two of the preceding values. In some embodiments, the cordon wires 865 support the plant as it grows within the fruiting zone.

In some embodiments, a width of the trellis system 800 is at least about 1 foot, 2 feet, 3 feet, 4 feet, 5 feet, 6 feet, 7 feet, 8 feet, 9 feet, 10 feet, 11 feet, 12 feet, or more. In some embodiments, a width of the trellis system 800 is at most about 12 feet, 11 feet, 10 feet, 9 feet, 8 feet, 7 feet, 6 feet, 5 feet, 4 feet, 3 feet, 2 feet, 1 foot, or less. In some embodiments, a width of the trellis system is within a range defined by any two of the preceding values. For instance, in some embodiments, a width of the trellis system 800 is about 3 feet to about 12 feet. In some embodiments, a maximum distance between the trellis arms 861 is at least about 1 foot, 2 feet, 3 feet, 4 feet, 5 feet, 6 feet, 7 feet, 8 feet, 9 feet, 10 feet, 11 feet, 12 feet, or more. In some embodiments, a maximum distance between the trellis arms 861 is at most about 12 feet, 11 feet, 10 feet, 9 feet, 8 feet, 7 feet, 6 feet, 5 feet, 4 feet, 3 feet, 2 feet, 1 foot, or less. In some embodiments, a maximum distance between the trellis arms 861 is within a range defined by any two of the preceding values. For instance, in some embodiments, a maximum distance between the trellis arms 861 is about 3 feet to about 12 feet.

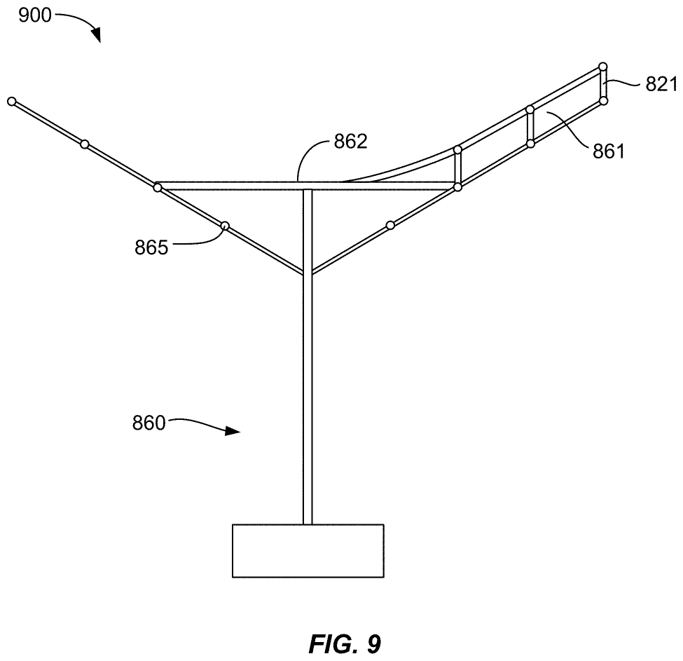

FIG. 9 displays an illustration of a second exemplary gable trellis system 900 for sunlight delivery, shoot positioning, and canopy division of one or more plants. In comparison with the first exemplary gable trellis system 800 of FIG. 8, the second exemplary gable trellis system 900 shown in FIG. 9 comprises first, second, and third risers instead of a first riser and first and second drops. Moreover, the second exemplary gable trellis system 900 comprises only a single crossarm in comparison to the two crossarms of the first exemplary gable trellis system 800 and four cordon wires in comparison to the two cordon wires of the first exemplary gable trellis system 800. Though so depicted in FIG. 9, the second exemplary gable trellis system may comprise any number of risers, drops, crossarms, and cordon wires described herein.

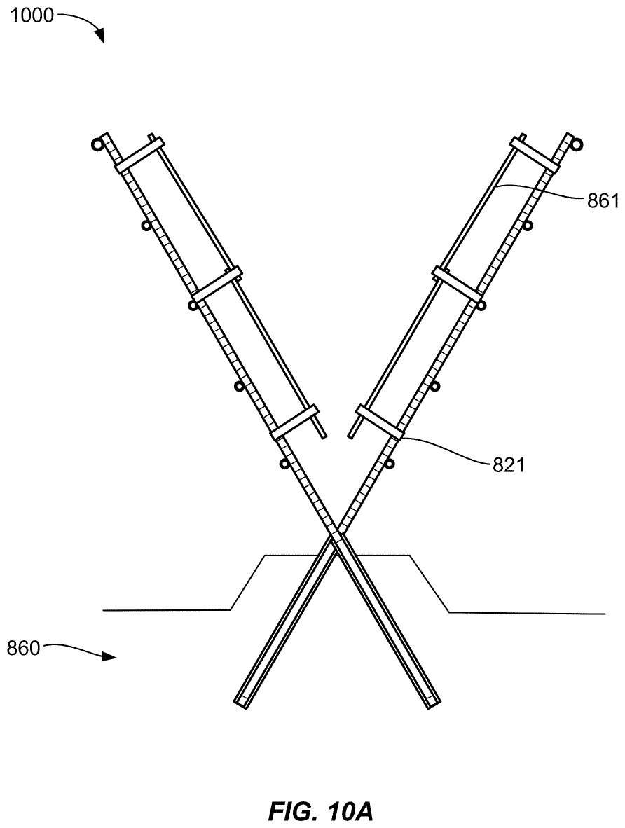

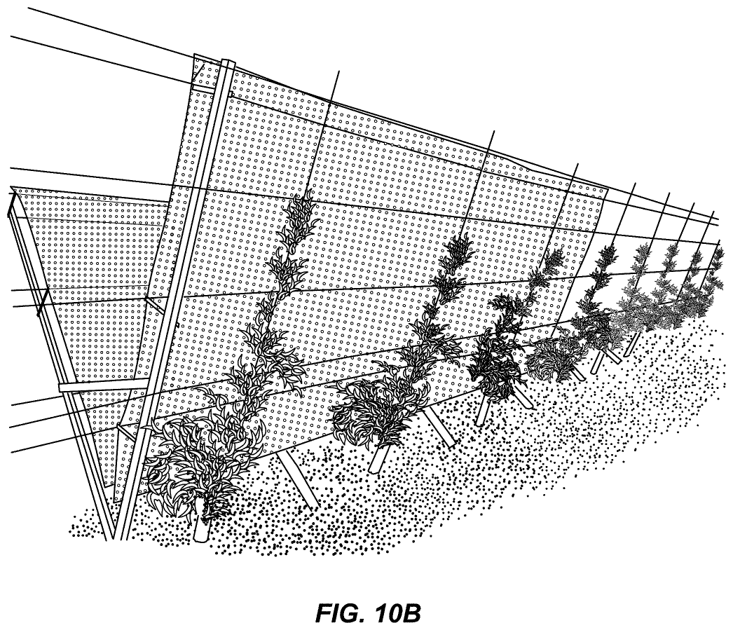

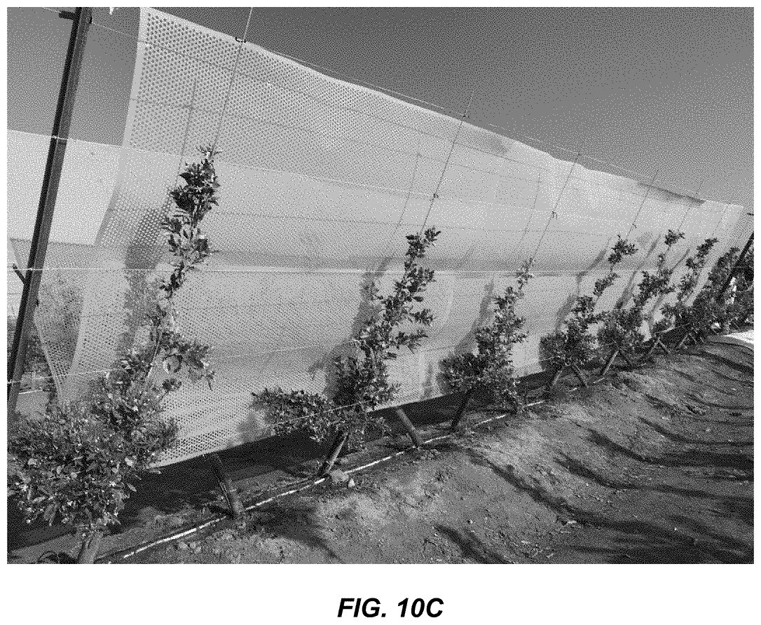

FIG. 10A displays an illustration of an exemplary Tatura trellis system 1000 for sunlight delivery, shoot positioning, and canopy division of one or more plants. In comparison with the first exemplary gable trellis system 800 of FIG. 8, the exemplary Tatura trellis system 1000 shown in FIG. 10 comprises first, second, and third risers instead of a first riser and first and second drops. Moreover, the exemplary Tatura trellis system 1000 comprises zero crossarms in comparison to the two crossarms of the first exemplary gable trellis system 800. Though so depicted in FIG. 10, the exemplary Tatura trellis system may comprise any number of risers, drops, and crossarms described herein.

FIG. 10B displays an illustration of the exemplary Tatura trellis system 1000 coupled to plants. In this embodiment, the Tatura trellis system 1000 was coupled to 48 inch wide panels.

FIG. 10C displays a photograph corresponding to FIG. 10B.

### Transmission Spectra

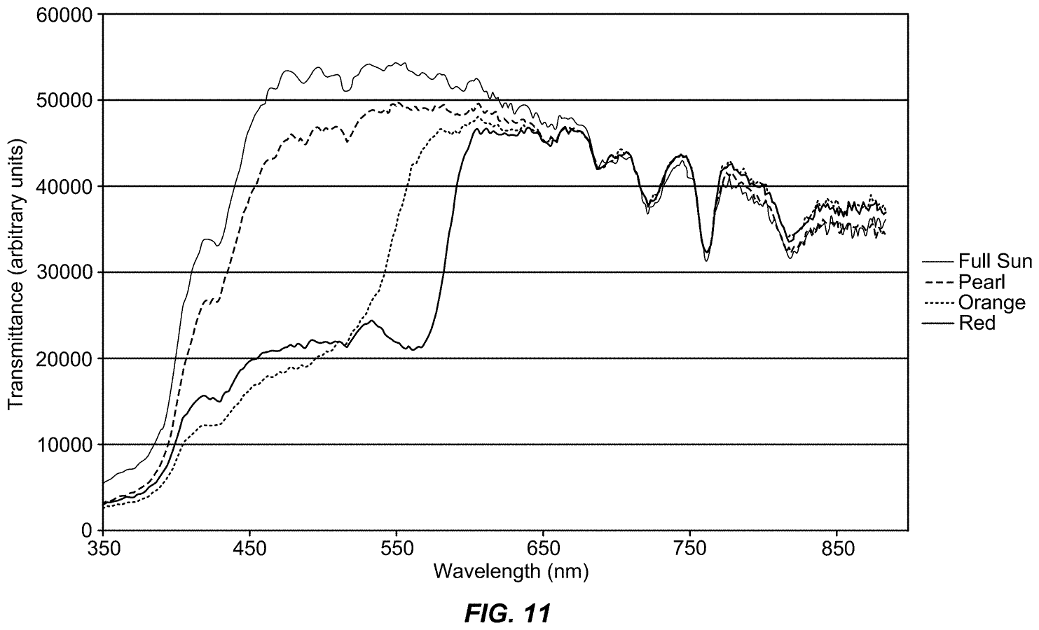

FIG. 11 displays exemplary transmission spectra through plastic panels of different colors. As shown in FIG. 11, panels that were red, orange, and pearl in color allow nearly full transmittance of the solar spectrum at wavelengths longer than about 600 nm. At shorter wavelengths, however, the panels are significantly less transmissive of light. The red panels, orange, and pearl panels significantly reduced transmission of wavelengths shorter than about 600 nm, about 570 nm, and about 470 nm, respectively. This clearly demonstrates that the panel color has a significant effect on the growth character of the light that reaches the plants.

### Plants

In some embodiments, the one or more plants comprise one or more vines. In some embodiments, the one or more vines comprise one or more members selected from the group consisting of: grape vines, kiwifruit vines, berry vines, blueberry vines, blackberry vines, raspberry vines, strawberry vines, melon vines, watermelon vines, cantaloupe vines, and honeydew vines. In some embodiments, the one or more plants comprise one or more trees. In some embodiments, the one or more trees comprise one or more members selected from the group consisting of: fruit trees, apple trees, stone-fruit trees, cherry trees, peach trees, nectarine trees, plum trees, apricot trees, citrus trees, orange trees, lemon trees, lime trees, grapefruit trees, pomelo trees, and tangerine trees.

### EXAMPLES

### Example 1: Flame Seedless Grapes

The trellis systems described herein were applied to the growth of flame seedless grapes. Two experiments were conducted on flame seedless grapes located within a few rows of one another. The first experiment involved trellis panels that did not utilize holes, while the second experiment involved trellis panels that include holes and had a boat-like shape. Both experiments were statistically designed as completely randomized blocks with six replications, statistical analysis by analysis of variance (ANOVA), mean separation by least significant difference. Fruit characteristics were measured on five occasions, twice before harvest began and then just prior to each of the three harvests for a total of five samplings. Measurements included berry weight, length, and width, and firmness. Berries were macerated and the resulting solution was evaluated for sugar and acid.

The potential yield for both experiments are shown in Tables 1 and 2. This was based on counting clusters in each plot. The average cluster weight was 1 pound, vine density was 518 vines per acre, and a packed box weight was 19 pounds. Using this data, the potential yield for each plot was calculated and reported as boxes per acre. There were no significant differences in total potential yield between the two experiments and the coefficient of variation between plots was reasonable (about 10%). The percentage packed treatment values were calculated as boxes packed divided by potential yield (boxes available to be packed).

This trellis panels in the first experiment (no holes) increased the percentage of fruit packed 40% compared to 24% for the unleafed control. The amount of total fruit harvested for the leafed control was 42%. For the second experiment (with holes), the amount of total fruit harvested was 65% compared to 49% for the control. Both of these treatments were leafed.

The first and second experiments were in close proximity to one another in the vineyard. It is interesting to note that the total fruit harvested from leafed control vines in each experiment was similar (42% and 49%, respectively), as shown in Tables 3 and 4. The similarity in results comparing the two experiments adds confidence to the results. It also suggests that the performance of trellis panels utilizing holes was good and likely similar to the original design.

The result from the first experiment verifies results obtained a year ago. The trellis panels without holes increased the number of boxes picked on the first pick by 77% in this experiment and by 61% in the previous year's trial. The total harvest for all three picks was also increased, by 16% this year and 11% last year, as shown in Table 3.

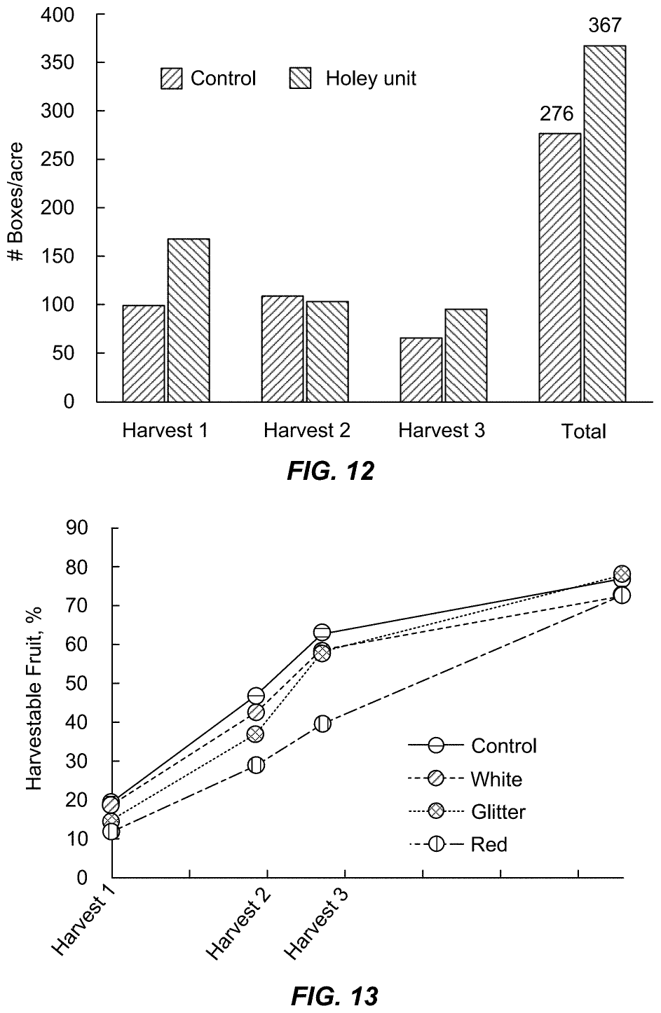

The results from the second experiment aligned nicely with the results from the first experiment. The first pick was 97% greater than control. Harvests from the trellis panels with holes and control treatments were similar on the second pick, but the harvest from the trellis panels with holes was greater on the last pick. The total for all three picks showed that the yield from the trellis panels with holes was significantly higher (32%) compared to the control, as shown in Table 4. FIG. 12 displays harvest yields for trellis panels that include holes and had a boat-like shape in comparison to a control and corresponds to the results displayed in Table 4. As shown in FIG. 12, the holey units resulted in a 40% increase in crop value compared to the control. Grapes coupled to the holey units also ripened earlier in the season and had increased berry sizes, widths, and lengths in comparison to the control.

In the first experiment, there was no difference in sugar comparing the unleafed first experiment with the leafed control treatment. However, both had significantly higher sugar compared to the unleafed control. This suggests that light was the primary factor, lack of which reduced sugar accumulation in the unleafed control, and that the first experiment was as effective as leafing in providing light.

The second experiment increased berry weight, width, and length compared to the control. After leafing, shoots and side shoots continue to grow and the improvement in the light environment that results from leafing is lost within a few weeks. But, with the application of trellis panels without holes, the improvement in the light environment continues. There is a suggestion that the trellis panels without holes improve berry firmness, as shown in Table 6.

For all tables, L.S.D. is the treatment mean separation by least significant difference; “n.s.” means no significance, * signifies a 10% level of significance, ** signifies a 5% level of significance, *** signifies a 1% level of significance, and C.V. is the coefficient of variation calculated as the standard deviation as a percentage of the general mean.

TABLE 1
Yield potential (boxes per acre) for first experiment.

| | East Boxes | West Boxes | Total Boxes |
|---|---|---|---|
| Treatment | per Acre | per Acre | per Acre |
| No-holes units, no | 332 | 339 | 673 |
| leafing | | | |
| Control, no leafing | 315 | 353 | 668 |
| Control, leafing | 379 | 359 | 739 |
| Significance | * | n.s. | n.s |
| L.S.D. 0.05 | 58 | | |
| C.V. | 9.8% | 16.0% | 10.3% |

TABLE 2
Yield potential (boxes per acre) for second experiment.

| | East Boxes | West Boxes | Total Boxes |
|---|---|---|---|
| Treatment | per Acre | per Acre | per Acre |
| Holey units, no | 269 | 298 | 568 |
| leafing | | | |
| Control | 276 | 277 | 553 |
| Significance | n.s. | n.s. | n.s |
| L.S.D. 0.05 | | | |
| C.V. | 13.0% | 11.7% | 7.5% |

TABLE 3
Flame seedless harvest results for first experiment

| | First Harvest | | | | Second Harvest | | | |
|---|---|---|---|---|---|---|---|---|
| | East | West | Total | | East | West | Total | |
| | Boxes | Boxes | Boxes | | Boxes | Boxes | Boxes | |
| | per | per | per | | per | per | per | |
| Treatment | Acre | Acre | Acre | % | Acre | Acre | Acre | % |
| No-holes | 65 | 44 | 110 | 16.4% | 30 | 19 | 50 | 7.4% |
| units, no | | | | | | | | |
| leafing | | | | | | | | |
| Control, no | 36 | 25 | 62 | 9.3% | 40 | 11 | 52 | 7.8% |
| leafing | | | | | | | | |
| Control, | 22 | 50 | 73 | 9.9% | 109 | 62 | 171 | 23.1% |
| leafing | | | | | | | | |
| Significance | n.s. | n.s. | * | | ** | *** | *** | |
| L.S.D. 0.05 | | | 33 | | 70 | 36 | 91 | |
| C.V. | 54% | 59% | 40% | | 67% | 66% | 57% | |
| | Third Harvest | | | | Total Harvest | | | |
| | East | West | Total | | East | West | Total | |
| | Boxes | Boxes | Boxes | | Boxes | Boxes | Boxes | |
| | per | per | per | | per | per | per | |
| Treatment | Acre | Acre | Acre | % | Acre | Acre | Acre | % |
| No holes | 61 | 47 | 109 | 16.2% | 156 | 141 | 269 | 40.0% |
| units, no | | | | | | | | |
| leaf | | | | | | | | |
| Control, no | 20 | 29 | 49 | 7.3% | 96 | 106 | 163 | 24.4% |
| leafing | | | | | | | | |
| Control, | 22 | 47 | 47 | 9.3% | 153 | 268 | 313 | 42.4% |
| leafing | | | | | | | | |
| Significance | *** | n.s. | *** | | * | *** | ** | |
| L.S.D. 0.05 | 19 | | 29 | | 40 | 57 | 111 | |
| C.V. | 31% | 39% | 22% | | 29% | 29% | 25% | |

Percentage based on actual yield compared to potential yield (Table 1). To convert boxes per acre to clusters per vine, multiply boxes by 0.147.

TABLE 4
Flame seedless harvest results for second experiment

| | First Harvest | | | | Second Harvest | | | |
|---|---|---|---|---|---|---|---|---|
| | East | West | Total | | East | West | Total | |
| | Boxes | Boxes | Boxes | | Boxes | Boxes | Boxes | |
| | per | per | per | | per | per | per | |
| Treatment | Acre | Acre | Acre | % | Acre | Acre | Acre | % |
| Holey units, | 87 | 82 | 168 | 29.6% | 43 | 60 | 103 | 18.1% |
| no leafing | | | | | | | | |
| Control | 44 | 55 | 99 | 17.9% | 45 | 64 | 109 | 19.7% |
| Significance | n.s. | * | n.s. | | n.s. | n.s. | n.s. | |
| L.S.D. 0.05 | | 42 | | | | | | |
| C.V. | 72% | 64% | 65% | | 42% | 33% | 19% | |
| | Third Harvest | | | | Total Harvest | | | |
| | East | West | Total | | East | West | Total | |
| | Boxes | Boxes | Boxes | | Boxes | Boxes | Boxes | |
| | per | per | per | | per | per | per | |
| Treatment | Acre | Acre | Acre | % | Acre | Acre | Acre | % |
| Holey units, | 60 | 35 | 95 | 16.7% | 191 | 176 | 367 | 64.6% |
| no leafing | | | | | | | | |
| Control | 37 | 29 | 66 | 11.9% | 127 | 149 | 276 | 49.9% |
| Significance | n.s | n.s. | * | | * | n.s. | * | |
| L.S.D. 0.05 | | | 27 | | 63 | | 90 | |
| C.V. | 49% | 84% | 31% | | 38.9% | 30.7% | 37% | |

Percentage based on actual yield compared to potential yield (Table 2). To convert boxes per acre to clusters per vine, multiply boxes by 0.147.

TABLE 5
Flame seedless fruit characteristics comparing
trellis panels having no holes with controls

| | Sugar (Brix) | | | Berry Weight (g) | | |
|---|---|---|---|---|---|---|
| Treatment | Harvest 1 | Harvest 2 | Harvest 3 | Harvest 1 | Harvest 2 | Harvest 3 |
| No-holes | 14.2 | 15.1 | 15.7 | 4.8 | 5.2 | 5.1 |
| units, no | | | | | | |
| leafing | | | | | | |
| Control, no | 13.9 | 14.2 | 14.4 | 4.7 | 5.3 | 5.1 |
| leafing | | | | | | |
| Control, | 14.7 | 14.7 | 14.9 | 5.6 | 5.8 | 5.9 |
| leafing | | | | | | |
| Significance | n.s. | n.s. | ** | *** | * | ** |
| L.S.D. 0.05 | 1 | | 0.9 | 0.4 | 0.4 | 0.7 |
| C.V. | 4.1% | 14.7% | 4.0% | 4.5% | 7.4% | 8.4% |
| | Berry Width (mm) | | | Berry Length (mm) | | |
| Treatment | Harvest 1 | Harvest 2 | Harvest 3 | Harvest 1 | Harvest 2 | Harvest 3 |
| No-holes | 20.2 | 20.5 | 20.4 | 20.7 | 21.3 | 21.3 |
| units, no | | | | | | |
| leafing | | | | | | |
| Control, no | 20 | 20.8 | 20.4 | 20.2 | 21.5 | 20.9 |
| leafing | | | | | | |
| Control, | 21.2 | 21.5 | 21.3 | 21.8 | 22.1 | 22.2 |
| leafing | | | | | | |
| Significance | *** | * | * | *** | * | * |
| L.S.D. 0.05 | 0.6 | 0.7 | 0.9 | 0.6 | 0.6 | 0.4 |
| C.V. | 15.0% | 2.8% | 3.0% | 1.9% | 2.7% | 3.0% |
| | Solution Reaction (pH) | | | Berry Firmness (mm) | | |
| Treatment | Harvest 1 | Harvest 2 | Harvest 3 | Harvest 1 | Harvest 2 | Harvest 3 |
| No-holes | 3.8 | 3.9 | 4.1 | | | 80 |
| units, no | | | | | | |
| leafing | | | | | | |
| Control, no | 3.9 | 3.9 | 4.1 | | | 77 |
| leafing | | | | | | |
| Control, | 3.9 | 3.9 | 4.1 | | | 80 |
| leafing | | | | | | |
| Significance | n.s. | n.s. | n.s. | | | * |
| L.S.D. 0.05 | | | | | | 2.9 |
| C.V. | 1.9% | 1.9% | 1.2% | | | 2.8% |

TABLE 6
Flame seedless fruit characteristics comparing
trellis panels having holes with controls

| | Sugar (Brix) | | | Berry Weight (g) | | |
|---|---|---|---|---|---|---|
| Treatment | Harvest 1 | Harvest 2 | Harvest 3 | Harvest 1 | Harvest 2 | Harvest 3 |
| Holey units, | 15.2 | 15.5 | 15.3 | 5.6 | 5.9 | 5.6 |
| no leafing | | | | | | |
| Control | 15.4 | 15.4 | 15.6 | 5.3 | 5.4 | 5.4 |
| Significance | n.s. | n.s. | n.s. | n.s. | * | n.s. |
| L.S.D. 0.05 | | | | | 0.4 | |
| C.V. | 5.7% | 3.0% | 3.6% | 8.4% | 8.4% | 9.6% |
| | Berry Width (mm) | | | Berry Length (mm) | | |
| Treatment | Harvest 1 | Harvest 2 | Harvest 3 | Harvest 1 | Harvest 2 | Harvest 3 |
| Holey units, | 20.9 | 21.6 | 20.9 | 22.2 | 22.6 | 22.2 |
| no leafing | | | | | | |
| Control | 20.7 | 20.6 | 20.6 | 21.7 | 21.7 | 20.0 |
| Significance | n.s. | * | n.s. | n.s. | * | n.s. |
| L.S.D. 0.05 | | 0.9 | | | 0.7 | |
| C.V. | 2.4% | 3.1% | 3.2% | 3.0% | 3.9% | 3.9% |
| | Solution Reaction (pH) | | | Berry Firmness (mm) | | |
| Treatment | Harvest 1 | Harvest 2 | Harvest 3 | Harvest 1 | Harvest 2 | Harvest 3 |
| Holey units, | 3.8 | 3.9 | 4.1 | | | 82 |
| no leafing | | | | | | |
| Control | 3.7 | 4.0 | 4.0 | | | 80 |
| Significance | n.s. | n.s. | n.s. | | | n.s. |
| L.S.D. 0.05 | | | | | | |
| C.V. | 1.0% | 2.0% | 2.0% | | | 7.4% |

### Example 2: Krissy Seedless Grapes

This research was designed as a completely randomized block design with four treatments, six replications, and four vine plots. The experiments included controls with no panels, white metal panels, white glittery panels, and red panels. Statistical analysis was by ANOVA and treatment mean separation by least significant difference.

The red panel delayed early fruit color development, but later fruit color was similar for all experiments. Fruit color was similar for all panels when evaluated on the east and west side of the vine. As with fruit color, the red panel delayed sugar accumulation, but later sugar accumulation was similar for all experiments. Berry firmness, an important sensory quality, was similar for all experiments.

FIG. 13 illustrates the effect of different colored panels on the time to maturity of Krissy seedless grapes and corresponds to the results displayed in Table 7. As shown in FIG. 13, red panels delayed maturation. However, red panels enhanced fruitfulness is the following year.

TABLE 7
Impact of trellis panels on Krissy seedless
grape color development and harvestable fruit

| | Average Fruit Color (%) | | | Harvestable Fruit (%) | | |
|---|---|---|---|---|---|---|
| | Harvest | Harvest | Harvest | Harvest | Harvest | Harvest |
| Treatment | 1 | 2 | 3 | 1 | 2 | 3 |
| Control | 75.6 | 85.0 | 89.4 | 19.1 | 46.6 | 62.9 |
| White | 74.9 | 84.4 | 89.1 | 18.6 | 42.7 | 58.7 |
| Panel | | | | | | |
| Glitter | 67.0 | 78.7 | 88.7 | 14.5 | 36.9 | 58.0 |
| Panel | | | | | | |
| Red Panel | 69.7 | 79.1 | 83.9 | 11.9 | 28.9 | 39.7 |
| L.S.D. | 6.9 | 5.7 | 5.4 | n.s. | 11.8 | 16.7 |
| East | 73.0 | 81.8 | 87.8 | 15.4 | 36.1 | 55.4 |
| Cordon | | | | | | |
| West | 70.6 | 81.8 | 87.7 | 16.6 | 41.5 | 55.3 |
| Cordon | | | | | | |
| L.S.D. | n.s. | n.s. | n.s. | n.s. | n.s. | n.s. |

TABLE 8
Impact of trellis panels on Krissy seedless grape harvestable fruit
as measured by counting clusters remaining after each harvest

| | Harvestable Fruit Actual Count (% total) | | |
|---|---|---|---|
| Treatment | Harvest 1 | Harvest 2 | Harvest 3 |
| Control | 50.5 | 77.0 | 97.0 |
| White Panel | 36.7 | 72.2 | 96.5 |
| Glitter Panel | 39.1 | 77.9 | 96.1 |
| Red Panel | 27.3 | 72.7 | 98.0 |
| L.S.D. | 10.1 | n.s. | n.s. |
| East Cordon | 37.1 | 75.7 | 96.7 |
| West Cordon | 39.7 | 74.2 | 97.2 |
| L.S.D. | n.s. | n.s. | n.s. |

TABLE 9
Impact of trellis panels on Krissy seedless
grape fruit characteristics at first harvest

| | | | | Berry | Berry | Berry | Firmness |
|---|---|---|---|---|---|---|---|
| | Sugar | Acid (% | | Weight | Width | Length | (durofel |
| Treatment | (Brix) | Tartaric) | pH | (g) | (mm) | (mm) | units) |
| Control | 18.3 | 0.87 | 3.6 | 10.2 | 24.7 | 29.4 | 54 |
| White | 17.5 | 0.88 | 3.6 | 10.1 | 24.6 | 29.7 | 55 |
| Panel | | | | | | | |
| Glitter | 17.0 | 0.91 | 3.5 | 10.2 | 24.8 | 30.0 | 55 |
| Panel | | | | | | | |
| Red Panel | 17.3 | 0.95 | 3.5 | 9.7 | 24.2 | 28.7 | 52 |
| L.S.D. | 0.7 | n.s. | 0.04 | 0.38 | 0.4 | 1.0 | n.s. |
| C.V. | 5.3 | 12.8 | 1.89 | 3.87 | 2.0 | 2.7 | 6.6 |

TABLE 10
Impact of trellis panels on Krissy seedless
grape fruit characteristics at second harvest

| | | | | Berry | Berry | Berry | Firmness |
|---|---|---|---|---|---|---|---|
| | Sugar | Acid (% | | Weight | Width | Length | (durofel |
| Treatment | (Brix) | Tartaric) | pH | (g) | (mm) | (mm) | units) |
| Control | 19.9 | 0.46 | 3.8 | 10.5 | 25.2 | 30.1 | 54.5 |
| White | 19.8 | 0.46 | 3.8 | 10.5 | 24.4 | 29.9 | 55.0 |
| Panel | | | | | | | |
| Glitter | 20.0 | 0.49 | 3.8 | 10.6 | 24.7 | 30.3 | 53.1 |
| Panel | | | | | | | |
| Red Panel | 20.1 | 0.52 | 3.8 | 10.3 | 21.8 | 30.1 | 52.5 |
| L.S.D. | n.s. | n.s. | n.s. | n.s. | n.s. | n.s. | n.s. |
| C.V. | 4.7 | 15.6 | 1.4 | 5.1 | 18.2 | 2.2 | 4.8 |

TABLE 11
Impact of trellis panels on Krissy seedless
grape fruit characteristics at third harvest

| | | | | Berry | Berry | Berry | Firmness |
|---|---|---|---|---|---|---|---|
| | Sugar | Acid (% | | Weight | Width | Length | (durofel |
| Treatment | (Brix) | Tartaric) | pH | (g) | (mm) | (mm) | units) |
| Control | 20.5 | 0.46 | 3.9 | 10.8 | 25.4 | 29.9 | 52 |
| White | 20.6 | 0.46 | 3.9 | 10.8 | 25.3 | 30.5 | 56 |
| Panel | | | | | | | |
| Glitter | 21.1 | 0.49 | 3.9 | 11.1 | 25.2 | 30.0 | 50 |
| Panel | | | | | | | |
| Red Panel | 20.0 | 0.52 | 3.9 | 10.5 | 25.2 | 30.3 | 54 |
| L.S.D. | n.s. | n.s. | n.s. | n.s. | n.s. | n.s. | n.s. |
| C.V. | 4.6 | 15.1 | 1.7 | 4.9 | 3.5 | 2.6 | 10.9 |

TABLE 12
Impact of trellis panels on Krissy seedless grape cluster count
at the beginning of a growing season and cluster length

| | Total clusters at start of | |
|---|---|---|
| Treatment | season (number per vine) | Cluster length (mm) |
| Control | 48 | 220 |
| White Panel | 47 | 230 |
| Glitter Panel | 47 | 229 |
| Red Panel | 49 | 233 |
| L.S.D. | n.s. | n.s. |
| East Cordon | 25 | 236 |
| West Cordon | 23 | 220 |
| L.S.D. | 1.3 | 7.7 |

### Example 3: Comparison of Trellis Panels for Flame Seedless and Krissy Seedless Grapes

Flowers were counted for both the flame seedless and Krissy seedless experiments to determine the impact of a previous year's treatments on vine fruitfulness. The statistical design was a completely randomized block with six replications and four treatments. Treatments for flame seedless included a control treatment, a trellis panel with holes, a glitter trellis panel, and a red trellis panel. Treatments for Krissy seedless included a control treatment, a white trellis panel, a glitter trellis panel, and a red trellis panel. Statistical analysis was by analysis of variance (ANOVA).

There was no difference in flower counts between the east and west cordons for the Krissy seedless cultivar but a highly significant difference for the flame seedless cultivar (which had more flowers on the west cordon). For all cultivars, adequate light is required from May through June for bud differentiation, and some cultivars have a greater requirement than others. Flame seedless is very light-sensitive, which may explain why there would be more flowers on the more illuminated west side of the vine. Krissy seedless is less light-sensitive.

With Krissy seedless, the red panels significantly increased flower counts compared to the control and white panels. For flame seedless, the fruitfulness with the red panel was similar to the control and both the control and the red panel produced greater fruitfulness than white panels. All of this suggests that the red chromatic plays a greater role in flower cluster differentiation than other colors.

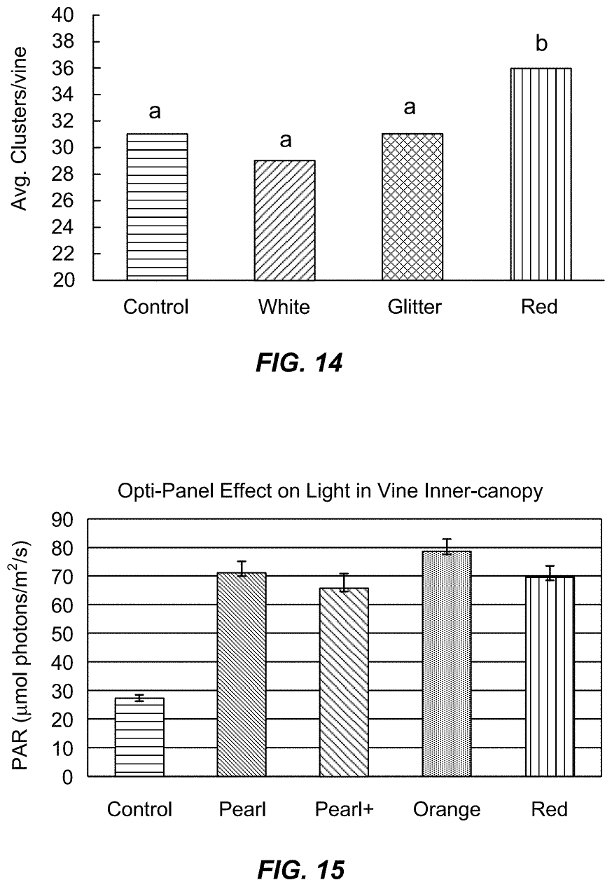

FIG. 14 illustrates the effect of different color panels on fruitfulness of Krissy seedless grapes one year after application of a trellis panel and corresponds to the results displayed in Table 13.

TABLE 13
Krissy seedless fruitfulness after application of a
trellis panel the prior year

| | Flower Clusters per Vine | | |
|---|---|---|---|
| Treatment | East Cordon | West Cordon | Total |
| Control | 14 | 17 | 31 |
| White Panel | 16 | 13 | 29 |
| Glitter Panel | 16 | 15 | 31 |
| Red Panel | 18 | 18 | 36 |
| L.S.D. | n.s. | n.s. | 3.8 |
| C.V. | 24% | 24% | 23% |
| East Cordon | 15.5 | | |
| West Cordon | 15.5 | | |
| L.S.D. | n.s. | | |
| C.V. | 24% | | |

TABLE 14
Flame seedless fruitfulness after application of a
trellis panel the prior year

| | Flower Clusters per Vine | | |
|---|---|---|---|
| Treatment | East Cordon | West Cordon | Total |
| Control | 16 | 19 | 35 |
| White Panel | 14 | 17 | 31 |
| Glitter Panel | 14 | 16 | 30 |
| Red Panel | 16 | 19 | 35 |
| L.S.D. | n.s. | n.s. | 3.9 |
| C.V. | 26% | 22% | 20% |
| East Cordon | 30 | | |
| West Cordon | 35 | | |
| L.S.D. | 4.2 | | |
| C.V. | 23% | | |

### Example 4: Enhancement of Light Intensity in Vine Inner Canopies Near Fruiting Zones

Light was measured on a clear sunny day in the early afternoon using an Apogee Instruments (Logan, Utah) hand-held Quantum Flux meter Model MQ-500. The experiment was carried out in a commercial Krissy seedless vineyard that utilized east-west row orientation. The vineyard was treated by best common practices, including leafing and centering (i.e. shoot pruning along the alleyway) for light penetration.

The experiment utilized 5 different conditions: a control that did not feature the panels described herein, treatments that utilized fully-holey polymer pearl, orange, and red panels described herein, and a treatment that used a partially-holey polymer pearl panel with a rain-protection strip (referred to as “Pearl+”). Each experimental condition covered a gable-to-gable section (4 vines). Panel sections and control sections were separated by buffer sections. The experimental layout was arranged in 8 fully randomized repetition blocks.

Light readings were collected from 15 different locations for each condition and each repetition on the north side of the vines at 165 cm height above ground level, just above the fruiting zone (which spans between 110 cm and 160 cm above ground level). The sensor was held horizontally facing south. The intensities were recorded as average photosynthetically active radiation (PAR) values in units of μmol photons*m⁻²*s⁻¹. The standard error was calculated from the 8 averaged values for each condition.

FIG. 15 illustrates the results of different colored panels on light intensity in vine inner canopies near fruiting zones. The panels described herein clearly increase the light intensities by more than 100% in all cases.

### Additional Aspects of the Invention

Aspect 1. A device for sunlight delivery, shoot positioning, and canopy division of one or more plants on a trellis, comprising one or more panels configured for coupling to the trellis, the panels configured to collect light energy and to direct the collected light energy to the plants, thereby modifying growth or development of the plants.
Aspect 2. The device of aspect 1, wherein the one or more panels are detachably coupled to the trellis.
Aspect 3. The device of aspect 1 or 2, wherein the one or more panels are physically coupled to the trellis.
Aspect 4. The device of any one of aspects 1-3, wherein the one or more panels are functionally coupled to the trellis.
Aspect 5. The device of any one of aspects 1-4, wherein the one or more panels comprise one or more reflective panels.
Aspect 6. The device of aspect 5, wherein the one or more reflective panels are configured to reflect the collected light energy to the plants, thereby directing the collected light energy to the climbing vine.
Aspect 7. The device of any one of aspects 1-6, wherein the one or more panels are red, yellow, or orange in color.
Aspect 8. The device of any one of aspects 5-7, wherein the one or more panels are configured to limit or eliminate reflection of blue light.
Aspect 9. The device of any one of aspects 5-8, wherein the one or more panels are configured to limit or eliminate reflection of ultraviolet (UV) light.
Aspect 10. The device of any one of aspects 1-6, wherein the one or more panels are blue in color.
Aspect 11. The device of any one of aspects 5-7, wherein the one or more panels are configured to limit or eliminate reflection of red, yellow, or orange light.
Aspect 12. The device of any one of aspects 1-11, wherein the one or more panels are translucent and transform direct light into a scattered light, a diffused light, or both.
Aspect 13. The device of any one of aspects 1-12, wherein the one or more panels comprise a curved shape.
Aspect 14. The device of aspect 13, wherein the one or more panels comprise a parabolic, partial parabolic, or compound parabolic shape.
Aspect 15. The device of any one of aspects 1-14, wherein the one or more panels comprise a metallic material.
Aspect 16. The device of any one of aspects 1-14, wherein the one or more panels comprise a plastic material, a metallic material, wood, carbon fiber, fiberglass, or any combination thereof.
Aspect 17. The device of any one of aspects 1-16, wherein the one or more panels comprise one or more holes therethrough.
Aspect 18. The device of aspect 17, wherein the one or more holes are configured to improve ventilation of the panels, to reduce heat load on the panels, to improve light transmission through the one or more panels, or any combination thereof.
Aspect 19. The device of aspect 17 or 18, wherein the one or more holes are sized to prevent ingress of the plant through the one or more holes.
Aspect 20. The device of aspect 19, wherein the one or more holes comprise a diameter of at most about 5 mm.
Aspect 21. The device of any one of aspects 17-20, further comprising one or more hole-closing units configured to close the one or more holes.
Aspect 22. The device of aspect 21, wherein the one or more hole-closing units comprise one or more secondary panels.
Aspect 23. The device of aspect 22, wherein the one or more secondary panels are configured to slide over the one or more panels.
Aspect 24. The device of aspect 21, wherein the one or more hole-closing units comprise one or more strips of solid material coupled to the one or more panels.
Aspect 25. The device of aspect 24, wherein the one or more strips of solid material are detachably coupled to the one or more panels.
Aspect 26. The device of aspect 24, wherein the one or more strips of solid material are integrally coupled to the one or more panels.
Aspect 27. The device of aspect 24, wherein the one or more strips of solid material are embedded in the one or more panels.
Aspect 28. The device of any one of aspects 1-27, wherein the one or more panels are configured to physically separate each plant of the one or more plants from each other plant of the one or more plants.
Aspect 29. The device of any one of aspects 1-28, wherein the one or more panels are configured to interlock.
Aspect 30. The device of any one of aspects 1-29, further comprising one or more curtains coupled to an edge of the one or more panels, the curtains configured to protect the plants from rain.
Aspect 31. The device of aspect 30, wherein the curtains comprise a metallic material.
Aspect 32. The device of aspect 31, wherein the curtains comprise a plastic material.
Aspect 33. The device of any one of aspects 1-32, wherein the one or more panels are configured to maintain an area behind the one or more panels clear of foliage from the plants.
Aspect 34. The device of any one of aspects 1-33, wherein the one or more panels are configured to train the plants on the trellis.
Aspect 35. The device of any one of aspects 1-34, wherein the one or more panels are configured to provide shade to the plants.
Aspect 36. The device of any one of aspects 1-35, wherein the one or more panels are configured to protect the plants from rain.
Aspect 37. The device of any one of aspects 1-36, wherein the one or more panels are configured to protect the plants from frost.
Aspect 38. The device of any one of aspects 1-37, wherein the one or more panels are configured to protect the plants from hail.
Aspect 39. The device of any one of aspects 1-38, wherein the one or more panels are configured to fold up into a center of the trellis to ease pruning of the plants.
Aspect 40. The device of any one of aspects 1-39, wherein the one or more plants comprise one or more vines.
Aspect 41. The device of aspect 40, wherein the one or more vines comprise one or more members selected from the group consisting of: grape vines, kiwifruit vines, berry vines, blueberry vines, blackberry vines, raspberry vines, strawberry vines, melon vines, watermelon vines, cantaloupe vines, and honeydew vines.
Aspect 42. The device of any one of aspects 1-39, wherein the one or more plants comprise one or more trees.
Aspect 43. The device of aspect 42, wherein the one or more trees comprise one or more members selected from the group consisting of: fruit trees, apple trees, stone-fruit trees, cherry trees, peach trees, nectarine trees, plum trees, apricot trees, citrus trees, orange trees, lemon trees, lime trees, grapefruit trees, pomelo trees, and tangerine trees.
Aspect 44. The device of any one of aspects 1-43, wherein the one or more panels comprise a portion of a roll of material.
Aspect 45. The device of aspect 44, wherein the roll comprises a plurality of the one or more panels.
Aspect 46. The device of aspect 44, wherein the roll of material comprises a continuous roll of material.
Aspect 47. The device of aspect 44, wherein the roll of material comprises a length of about 660 feet (201.168 meters).
Aspect 48. The device of aspect 44, wherein the roll of material comprises a length of about 1,320 feet (402.336 meters).
Aspect 49. A device for modifying growth development and fruit production of one or more plants on a trellis, comprising:
(a) one or more panels configured for coupling to the trellis; and
(b) a standoff coupled to the trellis and at least a portion of each of the one or more panels;
   wherein the panels are configured for dividing the growth of plant shoots on the trellis, thereby modifying growth or development of the plants.
      Aspect 50. The device of aspect 49, wherein the one or more panels are detachably coupled to the trellis.
      Aspect 51. The device of aspect 49 or 50, wherein the standoff is detachably coupled to the trellis.
      Aspect 52. The device of any one of aspects 49-51, wherein the one or more panels interlock.
      Aspect 53. The device of any one of aspects 49-52, wherein the one or more panels are reflective.
      Aspect 54. The device of any one of aspects 49-52, wherein the one or more panels are translucent.
      Aspect 55. The device of any one of aspects 49-52, wherein the one or more panels are chromatic.
      Aspect 56. The device of any one of aspects 49-55, wherein the one or more panels are formed of a metallic material, a plastic material, or any combination thereof.
      Aspect 57. The device of any one of aspects 49-56, wherein the one or more panels comprise a curved shape.
      Aspect 58. The device of aspect 57, wherein the one or more panels comprise a parabolic, partial parabolic, or compound parabolic shape.
      Aspect 59. The device of any one of aspects 49-58, wherein the one or more panels comprise one or more holes therethrough.
      Aspect 60. The device of aspect 59, wherein the one or more holes improve ventilation of the one or more panels, reduce a heat load on the one or more panels, improve light transmission through the one or more panels, or any combination thereof.
      Aspect 61. The device of aspect 59 or 60, wherein the one or more holes are sized to prevent ingress of the plant through the one or more holes.
      Aspect 62. The device of any one of aspects 59-61, wherein the one or more holes have a diameter of at most about 5 mm.
      Aspect 63. The device of any one of aspects 59-62, further comprising one or more hole-closing units configured to close the one or more holes.
      Aspect 64. The device of aspect 63, wherein the one or more hole-closing units comprise one or more secondary panels.
      Aspect 65. The device of aspect 64, wherein the one or more secondary panels are configured to slide over the one or more panels.
      Aspect 66. The device of aspect 63, wherein the one or more hole-closing units comprise one or more strips of solid material coupled to the one or more panels.
      Aspect 67. The device of aspect 66, wherein the one or more strips of solid material are detachably coupled to the one or more panels.
      Aspect 68. The device of aspect 66, wherein the one or more strips of solid material are integrally coupled to the one or more panels.
      Aspect 69. The device of aspect 66, wherein the one or more strips of solid material are embedded in the one or more panels.
      Aspect 70. The device of any one of aspects 49-69, further comprising one or more curtains coupled to an edge of the one or more panels.
      Aspect 71. The device of aspect 70, wherein the curtains are formed of a metallic material, a plastic material, a fabric, or both.
      Aspect 72. The device of any one of aspects 49-71, wherein the one or more panels are configured to physically separate a first portion of the plant from a second portion of the plant.
      Aspect 73. The device of any one of aspects 49-72, wherein the one or more panels are configured to train the plants on the trellis.
      Aspect 74. The device of any one of aspects 49-73, wherein the one or more panels are configured to provide shade to the plants.
      Aspect 75. The device of any one of aspects 49-74, wherein the one or more panels are configured to protect the plants from rain, frost, hail, wind, sunburn, or any combination thereof.
      Aspect 76. The device of any one of aspects 49-75, wherein the one or more panels are configured to fold up into a center of the trellis for pruning of the plants.
      Aspect 77. The device of any one of aspects 49-76, wherein the one or more panels are configured to allow illumination of an interior canopy of the one or more plants, a fruiting zone of the one or more plants, or both.
      Aspect 78. The device of any one of aspects 49-77, wherein the one or more panels are configured to reduce, increase, or maintain a temperature in a fruiting zone of the one or more plants.
      Aspect 79. The device of any one of aspects 49-78, wherein the one or more panels are configured to reduce light levels in a canopy of the one or more plants, a fruiting zone of the one or more plants, or both.
      Aspect 80. The device of any one of aspects 49-79, wherein the one or more panels are configured to scatter light in a canopy of the one or more plants, a fruiting zone of the one or more plants, or both.
      Aspect 81. The device of any one of aspects 49-80, wherein the one or more plants comprise one or more vines.
      Aspect 82. The device of aspect 81, wherein the one or more vines comprise one or more members selected from the group consisting of: grape vines, kiwifruit vines, berry vines, blueberry vines, blackberry vines, raspberry vines, strawberry vines, melon vines, watermelon vines, cantaloupe vines, and honeydew vines.
      Aspect 83. The device of any one of aspects 48-82, wherein the one or more plants comprise one or more trees.
      Aspect 84. The device of aspect 83, wherein the one or more trees comprise one or more members selected from the group consisting of: fruit trees, apple trees, stone-fruit trees, cherry trees, peach trees, nectarine trees, plum trees, apricot trees, citrus trees, orange trees, lemon trees, lime trees, grapefruit trees, pomelo trees, and tangerine trees.
      Aspect 85. The device of any one of aspects 49-84, wherein the standoff is formed of plastic, metal, wood, fiberglass, glass, or any combination thereof.
      Aspect 86. The device of any one of aspects 49-85, wherein the standoff has a length of about 4 inches to about 20 inches.
      Aspect 87. The device of any one of aspects 49-86, wherein the one or more panels have a length of about 40 inches to about 160 inches.
      Aspect 88. The device of any one of aspects 49-87, wherein the one or more panels comprise a portion of a roll of material.
      Aspect 89. The device of aspect 88, wherein the roll comprises a plurality of the one or more panels.
      Aspect 90. The device of aspect 88, wherein the roll of material comprises a continuous roll of material.
      Aspect 91. The device of aspect 88, wherein the roll of material comprises a length of about 660 feet (201.168 meters).
      Aspect 92. The device of aspect 88, wherein the roll of material comprises a length of about 1,320 feet (402.336 meters).
      Aspect 93. A method for sunlight delivery, shoot positioning, and canopy division of one or more plants on a trellis, comprising coupling one or more panels to the trellis, the panels configured to collect light energy and to direct the collected light energy to the plants, thereby modifying growth or development of the plants.
      Aspect 94. The method of aspect 93, wherein the one or more panels comprise the one or more panels of any of aspects 1-48.
      Aspect 95. A method for modifying growth development and fruit production of one or more plants on a trellis, comprising:
(c) coupling one or more panels to the trellis; and
(d) coupling one or more standoffs to the trellis and at least a portion of each of the one or more panels;
   wherein the panels are configured for dividing the growth of plant shoots on the trellis, thereby modifying growth or development of the plants.
      Aspect 96. The method of aspect 95, wherein the one or more panels comprise the one or more panels of any of aspects 49-92.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” “less than or equal to,” or “at most” precedes the first numerical value in a series of two or more numerical values, the term “no more than,” “less than,” “less than or equal to,” or “at most” applies to each of the numerical values in that series of numerical values. For example, less than or equal to 3, 2, or 1 is equivalent to less than or equal to 3, less than or equal to 2, or less than or equal to 1.

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

As used herein, the term “about” refers to an amount that is near the stated amount by 10%, 5%, or 1%, including increments therein.

As used herein, the term “about” in reference to a percentage refers to an amount that is greater or less the stated percentage by 10%, 5%, or 1%, including increments therein.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

What is claimed is:

1. A method for modifying growth development and fruit production of one or more plants on a trellis, comprising:
(a) coupling one or more panels to the trellis, and engaging the one or more plants; and
(b) coupling one or more standoffs to the trellis and at least a portion of each of the one or more panels;
(c) collecting light source energy from a light source above the one or more plants
(d) spectrally modifying the light source with the one or more panels;
(e) scattering the spectrally modified light in a diffused form towards the one or more plants, thereby stimulating and modifying the growth and development of the one or more plants; and
(f) engaging the one or more plants with the panel thereby dividing the one or more plants so growth of plant shoots on the trellis.

2. The method of claim 1, wherein the one or more panels are detachably coupled to the trellis.

3. The method of claim 1, wherein the one or more panels comprise a partially reflective portion.

4. The method of claim 1, wherein the one or more panels comprise one or more holes therethrough.

5. The method of claim 4, wherein the one or more holes are configured to improve ventilation of the panels, to reduce heat load on the panels, to improve light transmission through the one or more panels, or any combination thereof.

6. The method of claim 4, wherein the one or more holes are sized to prevent ingress of the one or more plants through the one or more holes.

7. The method of claim 4, wherein the one or more holes comprise a diameter of at most about 5 mm.

8. The method of claim 1, wherein the one or more panels are configured to interlock with one another on the trellis.

9. The method of claim 1, wherein the curtains comprise a plastic material, or a metallic material.

10. The method of claim 1, further comprising protecting the one or more plants from direct sun exposure, rain, frost, or hail by intercepting sunlight, rain, frost, or hail.

11. The method of claim 1, wherein spectrally modifying the light source comprises increasing transmission of red, yellow, or orange light.

12. The method of claim 1, wherein spectrally modifying the light source comprises reducing transmission of wavelengths of light shorter than about 600 nm, about 570 nm, or about 470 nm.

13. The method of claim 1, further comprising reducing the temperature in a fruiting zone of the one or more plants.

14. The method of claim 1, further comprising: reducing the time to harvest, increasing plant yield, reducing the amount water required by the one or more plants, or reducing the frequency of watering the one or more plants.

15. The method of claim 1, wherein the one or more plants comprises: grape vines, kiwifruit vines, berry vines, blueberry vines, blackberry vines, raspberry vines, strawberry vines, melon vines, watermelon vines, cantaloupe vines, honeydew vines.
